(19) United States
(12) Patent Application Publication
(10) Pub. No.: US 2007/0218404 A1
(43) Pub. Date: Sep. 20, 2007

(54) Infrared-sensitive lithographic printing plate

(75) Inventor: Noriaki Watanabe, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/714,743

(22) Filed: Mar. 7, 2007

(30) Foreign Application Priority Data
Mar. 15, 2006 (JP) 2006-070931

(51) Int. Cl. G03C 1/00

(52) U.S. Cl. 430/270.1

(57) ABSTRACT

An infrared-sensitive lithographic printing plate is provided that includes a support, a recording layer on one side of the support, the recording layer being capable of forming an image by irradiation with infrared rays, and a backcoat layer on the side of the support opposite to the side having the recording layer, the backcoat layer having a Vickers hardness of 0.2 or less.

### BACKGROUND OF THE INVENTION

1. Field of the Invention

The present invention relates to an infrared-sensitive lithographic printing plate and, in particular, to an infrared-sensitive lithographic printing plate having excellent scratch resistance.

2. Description of the Related Art

The development of lasers in recent years has been remarkable and, in particular, with regard to solid-state lasers and semiconductor lasers having emission regions from near-infrared to infrared, compact devices having high output are readily available. In particular, in the field of lithographic printing, these lasers are very useful as exposure light sources when carrying out direct plate-making using digital data from a computer, etc.

A positive-working lithographic printing plate for direct plate making employing such an infrared laser comprises as essential components an alkali-soluble resin and an infrared-absorbing agent that absorbs light and generates heat; in unexposed areas (image areas) this infrared-absorbing agent functions as a dissolution inhibitor that substantially degrades the solubility of the alkali-soluble resin by interacting with the alkali-soluble resin, and in exposed areas (non-image areas) heat generated therein weakens the interaction between the infrared-absorbing agent and the alkali-soluble resin, and the alkali-soluble resin dissolve in an alkaline developer, thereby forming an image. However, this positive-working lithographic printing plate does not have sufficient mechanical strength for a recording layer, and there is the problem that when the plate face comes into strong contact with various members during production, transport, and handling of the plate, defects are produced in the plate face, thus causing dropouts in the image area after development.

In order to suppress such a problem, lithographic printing plates are generally packaged with a slip sheet (an interleaf) between the plates. However, since this slip sheet has problems such as 1) an increase in cost and 2) disposal of the slip sheet, there is a desire for ‘slip sheet elimination’ where no slip sheet is used. In recent years in particular, accompanying the spread of CTP systems, exposure equipment is increasingly equipped with an automatic feeder (autoloader) for printing plates, and in order to avoid complications due to the slip sheets being specially manually removed in advance, there has been an increasing desire for the elimination of slip sheets.

With regard to techniques directed toward such elimination of slip sheets, the application to the reverse side of a support of a scheme for reducing mechanical damage to a photosensitive layer due to contact between the photosensitive layer and the reverse side of the support is known.

For example, it is stated that it is possible to stack, without a slip sheet, offset printing recording materials having a radiation-sensitive layer and an organic polymer-containing backcoat layer, the backcoat comprising a pigment such as silica gel, and the organic polymer having a glass transition temperature of 35° C. or greater (ref. e.g. JP-A-2002-46363 (JP-A denotes a Japanese unexamined patent application publication)). However, when the backcoat layer contains an inorganic pigment such as silica gel, since the inorganic pigment has high hardness, there is the problem that when products that are stacked and packaged without a slip sheet are transported, the photosensitive layer is easily damaged due to rubbing.

Moreover, a photosensitive lithographic printing plate is known in which a covering layer comprising at least one type of resin selected from the group consisting of a saturated copolymer polyester resin, a phenoxy resin, a polyvinyl acetal resin, and a vinylidene chloride copolymer resin is provided on the side of the support opposite to the photosensitive layer, the resin having a glass transition temperature of 60° C. or greater (ref. e.g. JP-A-2005-62456). It has been found that when lithographic printing plates having such a backcoat layer employing an organic polymer such as a polyester resin are fed in a stacked state without a slip sheet in an autoloader for automatically supplying plates to a laser exposure machine, the structure being such that the photosensitive layer and the reverse side (backcoat layer) are pressed against each other, the photosensitive layer is easily rubbed and scratched.

### BRIEF SUMMARY OF THE INVENTION

It is an object of the present invention to solve the above-mentioned problems and to provide an infrared-sensitive lithographic printing plate having sufficient scratch resistance under all conditions where scratch resistance is required, including transport when packaged without a slip sheet.

As a result of an intensive investigation by the present inventors, it has been found that the above-mentioned object can be attained by the photosensitive lithographic printing plate below, and the present invention has thus been accomplished. That is, the infrared-sensitive lithographic printing plate of the present invention comprises on one side of a support a recording layer that can form an image by irradiation with infrared rays and on the side of the support opposite to the side having the recording layer a backcoat layer having a Vickers hardness of 0.2 or less.

One embodiment of the lithographic printing plate of the present invention is the infrared-sensitive lithographic printing plate wherein the recording layer comprises an infrared-absorbing agent.

### DETAILED DESCRIPTION OF THE INVENTION

The infrared-sensitive lithographic printing plate of the present invention (hereinafter, also called simply a ‘lithographic printing plate’) comprises on one side of a support a recording layer that can form an image by irradiation with infrared rays and on the side of the support opposite to the side having the recording layer a backcoat layer having a Vickers hardness of 0.2 or less.

The present invention is explained in detail below.

### Backcoat Layer

It is essential for the infrared-sensitive lithographic printing plate of the present invention to have on the side of the support opposite to the side having a recording layer, which will be described later, a backcoat layer having a Vickers hardness of 0.2 or less.

The Vickers hardness (Hv) of the backcoat layer of the infrared-sensitive lithographic printing plate of the present invention is 0.2 or less, preferably 0.15 or less, more preferably 0.1 or less, and particularly preferably 0 to 0.03. It is preferable for it to be in the above-mentioned range since an infrared-sensitive lithographic printing plate having sufficient scratch resistance can be obtained.

It is essential that the infrared-sensitive lithographic printing plate of the present invention comprises a backcoat layer having a Vickers hardness of 0.2 or less. This value of 0.2 or less for the Vickers hardness is a value that is no greater than the hardness of a normally used slip sheet. That is, when the hardness is greater than 0.2, it is harder than the slip sheet, and when products packaged in a stacked state without a slip sheet are transported, they are more easily scratched than is the case when a slip sheet is employed. Furthermore, when plates are fed by an autoloader, the effect in reducing the stress when the recording layer and the reverse side are pressed against each other can be expected to be smaller than that of the slip sheet. On the other hand, when the Vickers hardness is 0.2 or less, it is softer than the slip sheet and scratching is prevented, and the effect in reducing the stress when the recording layer and the reverse side are pressed against each other can be expected to be higher than that of the slip sheet.

In accordance with the present invention, there can be provided an infrared-sensitive lithographic printing plate for which, even when stacked without a slip sheet, scratching of the recording layer during transport is suppressed effectively, and which can suitably be used in exposure equipment equipped with an automatic feeder (autoloader).

The Vickers hardness of the backcoat layer of the infrared-sensitive lithographic printing plate of the present invention may be measured by a known method, and the following measurement conditions are employed.

### Triboscope Measurement Conditions

Measurement equipment: Multimode AFM (manufactured by Veeco)+Triboscope (manufactured by Hysitron)

### Indentor: Berkovich type (S/N: TI-064)

Set load: 100 μN
Application speed: 20 μN/s
Maximum load duration: 2 s

### AFM Measurement Conditions

Measurement equipment: AFM (D3100/Nanoscope IIIa type, manufactured by Veeco)

### Cantilever: AC160TS manufactured by Olympus Imaging Corp.

With regard to a method for producing a backcoat layer having a Vickers hardness of 0.2 or less in the present invention, there is for example a method in which a photosensitive composition solution comprising a urethane oligomer and (or) acrylic oligomer, a polyfunctional unsaturated monomer, a polymerization initiator, and a solvent is applied, dried, and then cured by ultraviolet rays, a method in which various types of sheet-form rubber material such as natural rubber, isoprene rubber, styrene-butadiene rubber, butadiene rubber, chloroprene rubber, acrylonitrile-butadiene rubber, ethylene-propylene rubber, butyl rubber, fluorine rubber, silicone rubber, or urethane rubber are bonded by means of an adhesive, or a method in which a similar rubber is thermocompression-bonded or melt-laminated.

Among them, the method involving the application of a photosensitive composition solution is preferable since a thin layer can be provided efficiently.

Furthermore, with regard to materials for the backcoat layer having a Vickers hardness of 0.2 or less in the present invention, it is preferable to use a cured urethane oligomer and (or) acrylic oligomer or ethylene-propylene rubber, and more preferably a cured urethane oligomer and (or) acrylic oligomer, and it is particularly preferable to use a cured urethane oligomer. As the urethane oligomer, a urethane acrylate oligomer is particularly preferable. This urethane acrylate oligomer preferably has an average number of acrylate functional groups in the polyurethane acrylate oligomer of 2 to 6 and a molecular weight (Mw) by GPC (Gel Permeation Chromatography) of about 1,000 to 20,000. Such urethane acrylate oligomers include the violet light series UV-2010B and UV-3000B, which are commercially available from the Nippon Synthetic Chemical Industry Co., Ltd. A rubbery elastic type coating can be obtained by adding to such a urethane acrylate oligomer a UV polymerization initiator (Irgacure 184, Darocure 1173, etc.) and carrying out UV curing. This urethane acrylate oligomer is preferably used as 100% of the curing component. Furthermore, for a low molecular weight polyurethane acrylate oligomer such as UV-2010B, a low molecular weight polyol polyacrylate (2 to 4 acrylate functional groups) such as 1,6-hexanediol diacrylate (1,6-HDDA) or pentaerythritol tetraacrylate may preferably be used in combination at about 20 to 80 wt % relative to the polyurethane acrylate oligomer. As a UV irradiation light source, a high pressure mercury lamp can be cited as an example.

The above-mentioned photosensitive composition solution also preferably comprises a hydrophobic polymer compound.

Examples of the hydrophobic polymer compound include polybutene, polybutadiene, polyamide, an unsaturated copolymerized polyester resin, polyurethane, polyurea, polyimide, polysiloxane, polycarbonate, an epoxy resin, chlorinated polyethylene, an alkylphenol-aldehyde condensation resin, polyvinyl chloride, polyvinylidene chloride, polystyrene, an acrylic resin, copolymer resins thereof, hydroxycellulose, polyvinyl alcohol, cellulose acetate, and carboxymethylcellulose.

As other suitable hydrophobic polymer compounds, copolymers comprising the monomers listed in (1) to (12) below as constituent units and having a molecular weight of 10,000 to 200,000 can preferably be cited.

(1) acrylamides, methacrylamides, acrylic acid esters, methacrylic acid esters, and hydroxystyrenes that have an aromatic hydroxy group, such as, for example, N-(4-hydroxyphenyl)acrylamide, N-(4-hydroxyphenyl)methacrylamide, o-, m-, and p-hydroxystyrenes, and o-, m-, and p-hydroxyphenyl acrylates or methacrylates,

(2) acrylic acid esters and methacrylic acid esters that have an aliphatic hydroxy group, such as, for example, 2-hydroxyethyl acrylate and 2-hydroxyethyl methacrylate,

(3) (substituted) acrylic acid esters such as methyl acrylate, ethyl acrylate, propyl acrylate, butyl acrylate, amyl acrylate, hexyl acrylate, cyclohexyl acrylate, octyl acrylate, phenyl acrylate, benzyl acrylate, 2-chloroethyl acrylate, 4-hydroxybutyl acrylate, glycidyl acrylate, and N-dimethylaminoethyl acrylate,

(4) (substituted) methacrylic acid esters such as methyl methacrylate, ethyl methacrylate, propyl methacrylate, butyl methacrylate, amyl methacrylate, hexyl methacrylate, cyclohexyl methacrylate, octyl methacrylate, phenyl methacrylate, benzyl methacrylate, 2-chloroethyl methacrylate, 4-hydroxybutyl methacrylate, glycidyl methacrylate, and N-dimethylaminoethyl methacrylate,

(5) acrylamides or methacrylamides such as acrylamide, methacrylamide, N-methylolacrylamide, N-methylolmethacrylamide, N-ethylacrylamide, N-ethylmethacrylamide, N-hexylacrylamide, N-hexylmethacrylamide, N-cyclohexylacrylamide, N-cyclohexylmethacrylamide, N-hydroxyethylacrylamide, N-hydroxyethylmethacrylamide, N-phenylacrylamide, N-phenylmethacrylamide, N-benzylacrylamide, N-benzylmethacrylamide, N-riitrophenylacrylamide, N-nitrophenylmethacrylamide, N-ethyl-N-phenylacrylamide, and N-ethyl-N-phenylmethacrylamide,

(6) vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether,

(7) vinyl esters such as vinyl acetate, vinyl chloroacetate, vinyl butyrate, and vinyl benzoate,

(8) styrenes such as styrene, methylstyrene, and chloromethylstyrene,

(9) vinyl ketones such as methyl vinyl ketone, ethyl vinyl ketone, propyl vinyl ketone, and phenyl vinyl ketone,

(10) olefins such as ethylene, propylene, isobutylene, butadiene, and isoprene,

(11) N-vinylpyrrolidone, N-vinylcarbazole, 4-vinylpyridine, acrylonitrile, methacrylonitrile, etc.,

(12) acrylamides such as N-(o-aminosulfonylphenyl)acrylamide, N-(m-aminosulfonylphenyl)acrylamide, N-(p-aminosulfonylphenyl)acrylamide, N-[1-(3-aminosulfonyl)naphthyl]acrylamide, and N-(2-aminosulfonylethyl)acrylamide, methacrylamides such as N-(o-aminosulfonylphenyl)methacrylamide, N-(m-aminosulfonylphenyl)methacrylamide, N-(p-aminosulfonylphenyl)methacrylamide, N-[1-(3-aminosulfonyl)naphthyl]methacrylamide, and N-(2-aminosulfonylethyl)methacrylamide, unsaturated sulfonamides of acrylic acid esters, such as o-aminosulfonylphenyl acrylate, m-aminosulfonylphenyl acrylate, p-aminosulfonylphenyl acrylate, and 1-(3-aminosulfonylphenylnaphthyl)acrylate, and unsaturated sulfonamides of methacrylic acid esters, such as o-aminosulfonylphenyl methacrylate, m-aminosulfonylphenyl methacrylate, p-aminosulfonylphenyl methacrylate, and 1-(3-aminosulfonylphenylnaphthyl)methacrylate.

The backcoat layer may contain as necessary, in addition to these hydrophobic polymer compounds, a plasticizer, a surfactant, or another additive for the purpose of imparting flexibility, adjusting slip properties, or improving a coated surface condition.

Effective examples of the plasticizer include phthalic acid esters such as dimethyl phthalate, diethyl phthalate, dibutyl phthalate, diisobutyl phthalate, dioctyl phthalate, octylcapryl phthalate, dicyclohexyl phthalate, ditridecyl phthalate, butylbenzyl phthalate, diisodecyl phthalate, and diallyl phthalate, glycol esters such as dimethyl glycol phthalate, ethylphthalyl ethyl glycolate, methylphthalyl ethyl glycolate, butylphthalyl butyl glycolate, and triethylene glycol dicaprylate, phosphoric acid esters such as tricresyl phosphate and triphenyl phosphate, aliphatic dibasic acid esters such as diisobutyl adipate, dioctyl adipate, dimethyl sebacate, dibutyl sebacate, dioctyl azelate, and dibutyl maleate, polyglycidyl methacrylate, triethyl citrate, glycerol triacetyl ester, and butyl laurate.

The amount of plasticizer added to the backcoat layer depends on the type of organic polymer used in the backcoat layer, but it is preferable for it to be added in such a range that the glass transition temperature does not become equal to or less than 60° C.

Examples of the surfactant include anionic, cationic, nonionic, and amphoteric surfactants. Specific examples thereof include nonionic surfactants such as polyoxyethylene alkyl ethers, polyoxyethylene alkylphenyl ethers, polyoxyethylene polystyrylphenyl ethers, polyoxyethylene polyoxypropylene alkyl ethers, glycerin fatty acid partial esters, sorbitan fatty acid partial esters, pentaerythritol fatty acid partial esters, propylene glycol fatty acid monoesters, saccharose fatty acid partial esters, polyoxyethylene sorbitan fatty acid partial esters, polyoxyethylene sorbitol fatty acid partial esters, polyethylene glycol fatty acid esters, polyglycerin fatty acid partial esters, polyoxyethylene-linked castor oils, polyoxyethylene glycerin fatty acid partial esters, fatty acid diethanolamides, N,N-bis-2-hydroxyalkylamines, polyoxyethylenealkylamines, triethanolamine fatty acid esters, and trialkylamine oxides, anionic surfactants such as fatty acid salts, abietic acid salts, hydroxyalkanesulfonic acid salts, alkanesulfonic acid salts, dialkylsulfosuccinic acid esters, straight chain alkylbenzenesulfonic acid salts, branched alkylbenzenesulfonic acid salts, alkylnaphthalenesufonic acid salts, alkylphenoxypolyoxyethylene propylsulfonic acid salts,

polyoxyethylene alkylsulfophenyl ether salts, sodium N-methyl-N-oleyltaurate, N-alkylsulfosuccinic acid monoamide disodium salt, petroleum sulfonic acid salts, sulfated tallow oil, sulfates of fatty acid alkyl esters, alkyl sulfates, polyoxyethylene alkyl ether sulfates, fatty acid monoglyceride sulfates, polyoxyethylene alkylphenyl ether sulfates, polyoxyethylene styrylphenyl ether sulfates, alkyl phosphates, polyoxyethylene alkyl ether phosphates, polyoxyethylene alkylphenyl ether phosphates, partially saponified products of styrene/maleic anhydride copolymers, partially saponified products of olefin/maleic anhydride copolymers, and formalin condensation products of naphthalenesulfonates, cationic surfactants such as alkylamine salts, quaternary ammonium salts, polyoxyethylene alkylamine salts, and polyethylene polyamine derivatives, and amphoteric surfactants such as carboxybetaines, aminocarboxylic acids, sulfobetaines, aminosulfuric acid esters, and imidazolines. The polyoxyethylene in the surfactants described above can also be read to mean a polyoxyalkylene such as polyoxymethylene, polyoxypropylene, or polyoxybutylene, and they are also included in these surfactants.

Further preferred surfactants are fluorine-based surfactants containing a perfluoroalkyl group in the molecule. Examples of the fluorine-based surfactants include anionic type surfactants such as perfluoroalkylcarboxylic acid salts, perfluoroalkylsufonic acid salts, and perfluoroalkylphosphoric acid esters, amphoteric type surfactants such as perfluoroalkylbetaines, cationic type surfactants such as perfluoroalkyltrimethylammonium salts, and nonionic type surfactants such as perfluoroalkylamine oxides, perfluoroalkylethylene oxide adducts, oligomers containing perfluoroalkyl groups and hydrophilic groups, oligomers containing perfluoroalkyl groups and lipophilic groups, oligomers containing perfluoroalkyl groups, hydrophilic groups, and lipophilic groups, and urethanes containing perfluoroalkyl groups and lipophilic groups.

The above-mentioned surfactants may be used singly or as a mixture of two or more types thereof and added to the backcoat preferably in an amount ranging from 0.001 to 10 wt % and more preferably from 0.01 to 5 wt %.

The backcoat layer of the infrared-sensitive lithographic printing plate of the present invention may further contain as appropriate a dye for coloring, a silane coupling agent for improving adhesion to an aluminum support, a diazo resin comprising a diazonium salt, an organic phosphonic acid, an organic phosphoric acid, a cationic polymer, etc. and, furthermore, a wax normally used as a lubricant, a higher fatty acid, a higher fatty acid amide, a silicone compound comprising a dimethylsiloxane, a modified dimethylsiloxane, and a polyethylene powder.

The dry coat weight of the backcoat layer of the infrared-sensitive lithographic printing plate of the present invention is preferably 0.2 to 20 g/m², more preferably 0.5 to 10 g/m², and yet more preferably 0.8 to 5.0 g/m². When it is in the above-mentioned range, the effect of the backcoat layer in preventing scratches can be exhibited sufficiently.

With regard to a solvent used when the backcoat is formed by coating the reverse side of a support with a solution of an organic polymer and necessary components, organic solvents such as those described in JP-A-62-251739 are used singly or as a mixture. Examples of the solvent include ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethylsulfoxide, sulfolane, γ-butyrolactone, and toluene, but they should not be construed as being limited thereto. These solvents may be used singly or as a mixture.

### Recording Layer

The infrared-sensitive lithographic printing plate of the present invention has a recording layer that can form an image by irradiation with infrared rays (hereinafter, simply called a ‘recording layer’ or a ‘photosensitive layer’) on the side opposite to the side on which the backcoat layer is formed.

The recording layer of the infrared-sensitive lithographic printing plate of the present invention has a multi-layer structure of two or more layers, and comprises a recording layer lower layer containing a water-insoluble and alkali-soluble resin (hereinafter, also called simply a lower layer) and a recording layer uppermost layer containing a water-insoluble and alkali-soluble resin (hereinafter, also called simply an uppermost layer) in that order, and it is preferable for at least one of the lower layer and the uppermost layer of the recording layer to contain a photothermal conversion agent.

### Water-Insoluble and Alkali-Soluble Resin

The water-insoluble and alkali-soluble resin that can be used in the recording layer of the infrared-sensitive lithographic printing plate of the present invention (hereinafter called an ‘alkali-soluble resin’ as appropriate) includes a homopolymer containing an acidic group in its main chain and/or side chain, a copolymer thereof, and a mixture thereof. The recording layer of the lithographic printing plate of the present invention therefore has the property of dissolving on contact with an alkaline developer. The alkali-soluble resin used in the present invention is not particularly limited as long as it is known in the art, but is preferably a polymer compound having as an acidic group in the molecule at least one selected from (1) a phenolic hydroxyl group, (2) a sulfonamide group, (3) an active imide group, and (4) a carboxylic acid group. Examples thereof are illustrated below, but should not be construed as being limited thereto.

(1) With regard to the polymer compound having a phenolic hydroxyl group, there can be cited novolac resins such as a phenol-formaldehyde resin, a m-cresol-formaldehyde resin, a p-cresol-formaldehyde resin, an m-/p-mixed cresol-formaldehyde resin, and a mixed phenol-/cresol (any one of m-, p-, or m-/p-mixed)-formaldehyde resin, and pyrogallol-acetone resins.

Furthermore, with regard to the alkali-soluble resin having a phenolic hydroxy group, a resin formed by condensation between an aldehyde and a substituted phenol represented by Formula (I) below can also be cited as a preferred example.

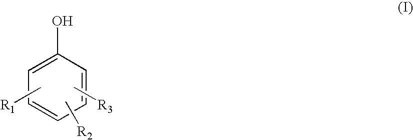

In Formula (I), R₁ and R₂ independently denote a hydrogen atom, an alkyl group, or a halogen atom. The alkyl group is preferably an alkyl group having 1 to 3 carbons, and more preferably an alkyl group having 1 or 2 carbons. The halogen atom is preferably any one of a fluorine atom, a chlorine atom, a bromine atom, and an iodine atom, and preferably a chlorine atom or a bromine atom. Moreover, R₃ denotes an alkyl group or a cycloalkyl group having 3 to 6 carbons.

Specific examples of the above-mentioned substituted phenol include isopropylphenol, t-butylphenol, t-amylphenol, hexylphenol, cyclohexylphenol, 3-methyl-4-chloro-6-tert-butylphenol, isopropylcresol, t-butylcresol, and t-amylcresol. Among them, t-butylphenol and t-butylcresol are preferable.

Examples of the aldehyde used in condensation with the above-mentioned substituted phenol include aliphatic and aromatic aldehydes such as formaldehyde, acetaldehyde, acrolein, and crotonaldehyde. Among them, formaldehyde and acetaldehyde are preferable.

With regard to other alkali-soluble resins having a phenolic hydroxyl group, a polymer compound having a phenolic hydroxyl group on its side chain can be cited. With regard to the polymer compound having a phenolic hydroxyl group on its side chain, there can be cited polymer compounds obtained by homopolymerization of a polymerizable monomer comprising a low molecular weight compound having at least one phenolic hydroxyl group and at least one polymerizable unsaturated bond, or by copolymerization of the monomer with another polymerizable monomer.

With regard to the polymerizable monomer having a phenolic hydroxyl group, there can be cited an acrylamide, a methacrylamide, an acrylic acid ester, and a methacrylic acid ester that have a phenolic hydroxyl group, a hydroxystyrene, etc. Specifically, N-(2-hydroxyphenyl)acrylamide, N-(3-hydroxyphenyl)acrylamide, N-(4-hydroxyphenyl)acrylamide, N-(2-hydroxyphenyl)methacrylamide, N-(3-hydroxyphenyl)methacrylamide, N-(4-hydroxyphenyl)methacrylamide, o-hydroxyphenyl acrylate, m-hydroxyphenyl acrylate, p-hydroxyphenyl acrylate, o-hydroxyphenyl methacrylate, m-hydroxyphenyl methacrylate, p-hydroxyphenyl methacrylate, o-hydroxystyrene, m-hydroxystyrene, p-hydroxystyrene, 2-(2-hydroxyphenyl)ethyl acrylate, 2-(3-hydroxyphenyl)ethyl acrylate, 2-(4-hydroxyphenyl)ethyl acrylate, 2-(2-hydroxyphenyl)ethyl methacrylate, 2-(3-hydroxyphenyl)ethyl methacrylate, and 2-(4-hydroxyphenyl)ethyl methacrylate may be suitably used. Such resins having a phenolic hydroxyl group may be used in a combination of two or more types.

Furthermore, with regard to the alkali-soluble resin having a phenolic hydroxy group used in the present invention, there can be cited an alkali-soluble resin, described in JP-A-11-288089, in which at least some of the phenolic hydroxy groups of the above-mentioned alkali-soluble resin having a phenolic hydroxy group have been esterified.

(2) With regard to the alkali-soluble resin having a sulfonamide group, there can be cited a polymer compound obtained by homopolymerization of a polymerizable monomer having a sulfonamide group or by copolymerization of the monomer with another polymerizable monomer. With regard to the polymerizable monomer having a sulfonamide group, there can be cited a polymerizable monomer comprising a low molecular weight compound having in the molecule at least one polymerizable unsaturated bond and at least one sulfonamide group (—NH—SO₂—) having at least one hydrogen atom bonded to the nitrogen atom. Among these, a low molecular weight compound having an acryloyl group, an allyl group, or a vinyloxy group, and having a substituted aminosulfonyl group or a substituted sulfonylimino group is preferable.

Specific examples of the alkali-soluble resin having a sulfonamide group include those described in JP-B-7-69605 (JP-B denotes a Japanese examined patent application publication).

(3) With regard to the alkali-soluble resin having an active imide group (—CO—NH—SO₂—), a polymer derived from a monomer having an active imide group in the molecule is preferable, and examples of this polymer compound include a polymer compound obtained by homopolymerization of a polymerizable monomer comprising a low molecular weight compound having in the molecule at least one active imide group and at least one more polymerizable unsaturated bond, or by copolymerization of the monomer with another polymerizable monomer.

Specific examples of such a compound that can be suitably used include N-(p-toluenesulfonyl)methacrylamide and N-(p-toluenesulfonyl)acrylamide.

(4) With regard to the alkali-soluble resin having a carboxylic acid group, there can be cited as examples polymer compounds obtained by homopolymerization of a polymerizable monomer comprising a low molecular weight compound having at least one carboxylic acid group and at least one polymerizable unsaturated group in the molecule, or by copolymerization of this monomer with another polymerizable monomer. Specific examples of the polymerizable monomer having a carboxylic acid group include α,β-unsaturated carboxylic acids such as acrylic acid, methacrylic acid, maleic acid, maleic anhydride, and itaconic acid. There also can be cited as suitable examples an unsaturated carboxylic acid that is a monoester of a dibasic acid (e.g. succinic acid, glutaric acid, phthalic acid) and a hydroxyl group of an acrylate or a methacrylate having a hydroxyl group on a side chain (e.g. 2-hydroxyethyl acrylate or methacrylate).

With regard to the alkali-soluble resin that can be used in the present invention, a polymer compound obtained by polymerization of two or more types from the polymerizable monomer having a phenolic hydroxyl group, the polymerizable monomer having a sulfonamide group, the polymerizable monomer having an active imide group, and the polymerizable monomer having a carboxylic acid group, or a polymer compound obtained by copolymerization of said two or more types of these polymerizable monomers with another polymerizable monomer may be used.

In the present invention, when the alkali-soluble polymer is a copolymer of another polymerizable monomer with the monomer having an acidic group (a phenolic hydroxyl group, a sulfonamide group, an active imide group, a carboxylic acid group) it is preferable for the monomer imparting alkali solubility to be present at 10 mol % or greater, and preferably at 20 mol % or greater. It is preferable for the copolymerization component to be present at 10 mol % or greater since sufficient alkali solubility can be obtained.

With regard to the monomer component that is copolymerized with the monomer having an acidic group, compounds listed in (m1) to (m11) below can be cited as examples, but the monomer component is not limited thereto.

(m1) Acrylic acid esters and methacrylic acid esters having an aliphatic hydroxyl group, such as 2-hydroxyethyl acrylate and 2-hydroxyethyl methacrylate.
(m2) Alkyl acrylates such as methyl acrylate, ethyl acrylate, propyl acrylate, butyl acrylate, amyl acrylate, hexyl acrylate, octyl acrylate, benzyl acrylate, 2-chloroethyl acrylate, and glycidyl acrylate.
(m3) Alkyl methacrylates such as methyl methacrylate, ethyl methacrylate, propyl methacrylate, butyl methacrylate, amyl methacrylate, hexyl methacrylate, cyclohexyl methacrylate, benzyl methacrylate, 2-chloroethyl methacrylate, and glycidyl methacrylate.
(m4) Acrylamides and methacrylamides such as acrylamide, methacrylamide, N-methylolacrylamide, N-ethylacrylamide, N-hexylmethacrylamide, N-cyclohexylacrylamide, N-hydroxyethylacrylamide, N-phenylacrylamide, N-nitrophenylacrylamide, and N-ethyl-N-phenylacrylamide.
(m5) Vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether.
(m6) Vinyl esters such as vinyl acetate, vinyl chloroacetate, vinyl butyrate, and vinyl benzoate.
(m7) Styrenes such as styrene, α-methylstyrene, methylstyrene, and chloromethylstyrene.
(m8) Vinyl ketones such as methyl vinyl ketone, ethyl vinyl ketone, propyl vinyl ketone, and phenyl vinyl ketone.
(m9) Olefins such as ethylene, propylene, isobutylene, butadiene, and isoprene.
(m10) N-Vinylpyrrolidone, acrylonitrile, methacrylonitrile, etc.
(m11) Unsaturated imides such as maleimide, N-acryloylacrylamide, N-acetylmethacrylamide, N-propionylmethacrylamide, and N-(p-chlorobenzoyl)methacrylamide.

The alkali-soluble resin may be prepared by a known graft copolymerization method, a known block copolymerization method, a known random copolymerization method, etc.

In the present invention, when the alkali-soluble resin is a homopolymer or copolymer of the polymerizable monomer having an acidic group, the weight-average molecular weight thereof is preferably 2,000 or greater, and more preferably 5,000 to 300,000. Furthermore, in the present invention, when the alkali-soluble resin is a resin such as a phenol-formaldehyde resin or a cresol-aldehyde resin, its weight-average molecular weight is preferably 500 to 50,000, more preferably 700 to 20,000, and particularly preferably 1,000 to 10,000.

As the alkali-soluble resin used in the uppermost layer of the photosensitive layer, the resin having a phenolic hydroxy group is desirable since strong hydrogen bonds are formed in an unexposed area and some of the hydrogen bonds are easily dissociated in an exposed area. A novolac resin is more preferable.

Furthermore, in the present invention, two or more types of alkali-soluble resins having different dissolution rates in an aqueous alkaline solution may be used as a mixture, and in this case the mixing ratio may be freely chosen. With regard to an alkali-soluble resin suitable for mixing with a resin having a phenolic hydroxy group suitably used in the case of the uppermost layer of the photosensitive layer, it is preferable to use an acrylic resin since miscibility with the resin having a phenolic hydroxy group is low, and it is more preferable to use an acrylic resin having a sulfonamide group or a carboxylic acid group.

The lower layer of the photosensitive layer employs the above-mentioned alkali-soluble resin, and it is necessary for the lower layer itself to exhibit high alkali solubility, particularly in a non-image area. Furthermore, it is necessary for it to exhibit resistance to various printing chemicals during printing and a stable lifetime under various printing conditions. Because of this, it is preferable to select a resin that does not impair these properties. From this viewpoint, it is preferable to select a resin that has excellent solubility in an alkaline developer, resistance to dissolution in various printing chemicals, and physical strength. Furthermore, with regard to the alkali-soluble resin used in the lower layer, it is preferable to select a resin having a low solubility in a solvent used for applying the uppermost layer so that the resin does not dissolve in the solvent. Selecting such a resin enables undesired miscibility at the interface between the two layers to be suppressed.

From these viewpoints, among the above-mentioned alkali-soluble resins, acrylic resins are preferable. Among them, an acrylic resin having a sulfonamide group is preferable.

From the above-mentioned viewpoints, with regard to the alkali-soluble resin used in the lower layer, other than those mentioned above, water-insoluble and alkali-soluble polyamide resins, epoxy resins, polyvinyl acetal resins, styrene-based resins, urethane resins, etc. can be cited. Among them, urethane resins and polyvinyl acetal resins are preferable.

The above-mentioned water-insoluble and alkali-soluble polyurethane resins (hereinafter, simply called ‘polyurethane resins’ as appropriate) are not particularly limited as long as they are insoluble in water and soluble in an aqueous alkaline solution; among them one having a carboxyl group in the polymer main chain is preferable, and specific examples thereof include a polyurethane resin having as a basic skeleton a reaction product between a diisocyanate compound represented by Formula (II) below and at least one type of diol compound having a carboxyl group represented by Formula (III) or Formula (IV) below.

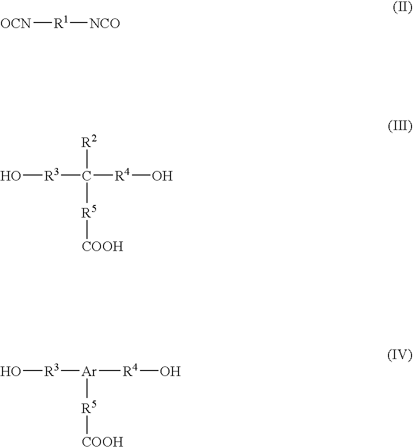

In Formula (II), R¹ denotes a divalent linking group. Examples of such a divalent linking group include an aliphatic hydrocarbon, an alicyclic hydrocarbon, and an aromatic hydrocarbon, and preferred examples thereof include an alkylene group having 2 to 10 carbons and an arylene group having 6 to 30 carbons. The arylene group may have a structure in which two or more ring structures are bonded via a single bond or a divalent organic linking group such as a methylene group or a condensed polycyclic structure. Furthermore, R¹ may have as necessary another functional group that does not react with an isocyanate group in Formula (II), such as, for example, an ester, urethane, amide, or ureido group.

Moreover, R¹ may have a substituent, and examples of the substituent that can be introduced include substituents that are inactive toward the isocyanate group, such as a halogen atom (—F, —Cl, —Br, —I), an alkyl group, an alkoxyl group, an alkyl ester group, and a cyano group.

Furthermore, examples of a diisocyanate compound used in the present invention include, in addition to those represented by Formula (II) above, a high molecular weight diisocyanate compound, that is, a polymer compound such as an oligomer or polymer comprising a diol compound, which will be described later, and having an isocyanate group at both termini.

In Formula (III), R² denotes a hydrogen atom, an alkyl group, an aralkyl group, an aryl group, an alkoxy group, or an aryloxy group. Here, R² may have a substituent, and examples of the substituent that can be introduced include a cyano group, a nitro group, a halogen atom (—F, —Cl, —Br, —I), —CONH₂, —COOR⁶, —OR⁶, —NHCONHR⁶, —NHCOOR⁶, —NHCOR⁶, —OCONHR⁶, and —CONHR⁶ (here, R⁶ denotes an alkyl group having 1 to 10 carbons or an aralkyl group having 7 to 15 carbons).

Preferred examples of R² include a hydrogen atom, an unsubstituted alkyl group having 1 to 8 carbons, and an unsubstituted aryl group having 6 to 15 carbons.

In Formulae (III) or (IV), R³, R⁴, and R⁵ may be identical to or different from each other, and denote a single bond, or a divalent linking group. Examples of such a divalent linking group include an aliphatic hydrocarbon and an aromatic hydrocarbon. Here, R³, R⁴, and R⁵ may have a substituent, and examples of the substituent that can be introduced include an alkyl group, an aralkyl group, an aryl group, an alkoxy group, and a halogen atom (—F, —Cl, —Br, —I).

Preferred examples of R³, R⁴, and R⁵ include an unsubstituted alkylene group having 1 to 20 carbons and an unsubstituted arylene group having 6 to 15 carbons, and more preferred examples thereof include an unsubstituted alkylene group having 1 to 8 carbons. Furthermore, R³, R⁴, and R⁵ may have as necessary another functional group that does not react with an isocyanate group in Formula (II) above, such as, for example, an ester, urethane, amide, ureido, or ether group.

Furthermore, two or three of R², R³, R⁴, and R⁵ may be bonded to each other to form a ring structure.

In Formula (IV), Ar denotes a trivalent aromatic hydrocarbon, which may have a substituent, and preferably an aromatic group having 6 to 15 carbons.

Specific examples of the diisocyanate compound represented by Formula (II) above include those below, but the present invention is not limited thereto.

Aromatic diisocyanate compounds such as 2,4-tolylene diisocyanate, 2,4-tolylene diisocyanate dimer, 2,6-tolylene diisocyanate, p-xylylene diisocyanate, metaxylylene diisocyanate, 4,4′-diphenylmethane diisocyanate, 1,5-naphthylenediisocyanate, and 3,3′-dimethylbiphenyl-4,4′-diisocyanate; aliphatic diisocyanate compounds such as hexamethylene diisocyanate, trimethylhexamethylene diisocyanate, lysine diisocyanate, and dimer acid diisocyanate; alicyclic diisocyanate compounds such as isophorone diisocyanate, 4,4′-methylenebis(cyclohexyl isocyanate), methylcyclohexane-2,4-(or -2,6-)diisocyanate, and 1,3-(isocyanatomethyl)cyclohexane; and diisocyanate compounds that are products of a reaction between a diol and a diisocyanate, such as an adduct of 1 mol of 1,3-butylene glycol and 2 mol of tolylene diisocyanate.

Among them, one having an aromatic ring such as 4,4′-diphenylmethane diisocyanate, xylylene diisocyanate, or tolylene diisocyanate is preferable from the viewpoint of scratch resistance.

Furthermore, specific examples of a carboxyl group-containing diol compound represented by Formula (III) or (IV) above include those shown below, but the present invention is not limited thereto.

3,5-Dihydroxybenzoic acid, 2,2-bis(hydroxymethyl)propionic acid, 2,2-bis(hydroxyethyl)propionic acid, 2,2-bis(3-hydroxypropyl)propionic acid, 2,2-bis(hydroxymethyl)acetic acid, bis(4-hydroxyphenyl)acetic acid, 4,4-bis(4-hydroxyphenyl)pentanoic acid, and tartaric acid.

Among them, 2,2-bis(hydroxymethyl)propionic acid and 2,2-bis(hydroxyethyl)propionic acid are preferable from the viewpoint of reactivity with an isocyanate.

The polyurethane resin that can be used in the present invention may be formed by using two or more types each of diisocyanate compounds represented by Formula (II) above and carboxyl group-containing diol compounds represented by Formula (III) or (IV).

Furthermore, in addition to the carboxyl group-containing diol compound represented by Formula (III) or (IV), there may used in combination, to such a degree that the alkali developability is not degraded, a diol compound that does not have a carboxyl group and that may have a substituent that does not react with an isocyanate group in Formula (II).

The polyurethane resin that can be used in the present invention may be synthesized by heating the above-mentioned diisocyanate compound and diol compound in an aprotic solvent with added thereto a known catalyst having activity required for the reactivities thereof.

The molar ratio of the diisocyanate and the diol compound used is preferably 0.8:1 to 1.2:1, and when an isocyanate group remains on the terminus of the polymer, by treating it with an alcohol or an amine, etc., the polymer can finally be synthesized in a form in which there are no remaining isocyanate groups.

The molecular weight of the polyurethane resin that can be used in the present invention is preferably 1,000 or greater as a weight-average molecular weight, and more preferably in the range of 5,000 to 100,000. These polyurethane resins may be used singly or in a combination of two or more types.

The water-insoluble and alkali-soluble polyvinyl resin is now explained. The polyvinyl acetal resin used here is not particularly limited as long as it is insoluble in water and soluble in an aqueous alkaline solution, but a polyvinyl acetal resin represented by Formula (V) below is particularly preferable.

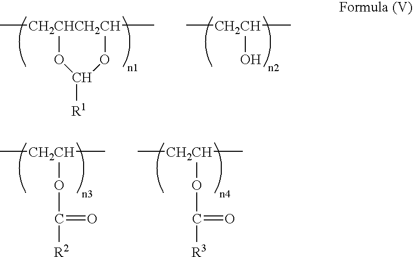

Constituent unit (i) Constituent unit (ii) Constituent unit (iii) Constituent unit (iv) [n1=5-85 mol %, n2=0-60 mol %, n3=0-20 mol %, n4=3-60 mol]

The polyvinyl acetal resin represented by Formula (V) above is formed from constituent units (i) to (iv) in which, among the above-mentioned constituent units, the constituent unit (i), which is a vinyl acetal component, and the constituent unit (iv), which is an ester component containing a carboxyl group, are essential components, and the constituent unit (ii), which is a vinyl alcohol component, and the constituent unit (iii), which is an unsubstituted ester component, are optional components, and may comprise at least one type of each of the constituent units. n1 to n4 denote the constituent ratios (mol %) of each constituent unit.

In the above-mentioned constituent unit (i), R¹ denotes an optionally substituted alkyl group, a hydrogen atom, a carboxyl group, or a dimethylamino group. Examples of the substituent include a carboxyl group, a hydroxyl group, a chlorine group, a bromine group, a urethane group, a ureido group, a tertiary amino group, an alkoxy group, a cyano group, a nitro group, an amide group, and an ester group.

Specific examples of R¹ include a hydrogen atom, a methyl group, an ethyl group, a propyl group, a butyl group, a pentyl group, a carboxy group, a methyl group substituted with a halogen atom (—Br, —Cl, etc.) or a cyano group, a 3-hydroxybutyl group, a 3-methoxybutyl group, and a phenyl group, and among them a hydrogen atom, a propyl group, and a phenyl group are particularly preferable.

n1 is preferably in the range of 5 to 85 mol %, and particularly preferably in the range of 25 to 70 mol %.

In the above-mentioned constituent unit (ii), n2 is preferably in the range of 0 to 60 mol %, and particularly preferably in the range of 10 to 45 mol %.

In the above-mentioned constituent unit (iii), R² denotes an unsubstituted alkyl group. In particular, an alkyl group having 1 to 10 carbons is preferable, and a methyl group and an ethyl group are particularly preferable from the viewpoint of developability.

n3 is preferably in the range of 0 to 20 mol %, and particularly preferably in the range of 1 to 10 mol %.

In the above-mentioned constituent unit (iv), R³ denotes a carboxyl group-containing aliphatic hydrocarbon group, alicyclic hydrocarbon group, or aromatic hydrocarbon group, and these hydrocarbon groups preferably have 1 to 20 carbons. Furthermore, these hydrocarbon groups in the constituent unit (iv) are preferably mainly hydrocarbon groups obtained by reacting residual OH of a polyvinyl acetal with an acid anhydride such as succinic anhydride, maleic anhydride, phthalic anhydride, trimellitic anhydride, or cis-4-cyclohexene-1,2-dicarboxylic anhydride, and among them a product obtained by a reaction with phthalic anhydride or succinic anhydride is more preferable. A product obtained by using another cyclic acid anhydride may also be used.

R³ may have a substituent other than a carboxyl group. Examples of such a substituent include those represented by the structures below.

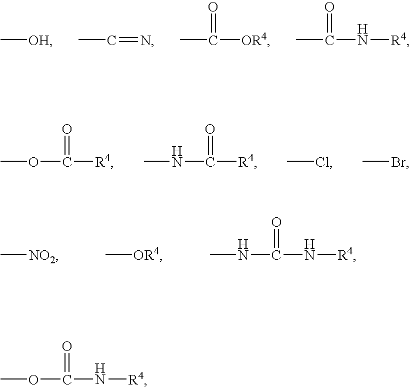

Specific examples of R³ include those illustrated below, but the present invention should not be construed as being limited thereto.

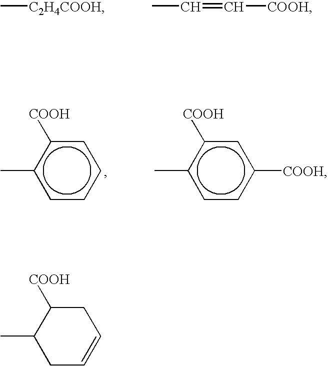

In the formulae above, examples of R⁴ include an optionally substituted alkyl group, aralkyl group, or aryl group having 1 to 20 carbons, and examples of the substituent that can be introduced include —OH, —C≡N, —Cl, —Br, and —NO₂.

Furthermore, n4 is preferably in the range of 3 to 60 mol % from the viewpoint of developability, and particularly preferably in the range of 10 to 55 mol %.

The polyvinyl acetal resin represented by Formula (V) above may be synthesized by a method in which a polyvinyl alcohol is acetalized with an aldehyde, and residual hydroxy groups are reacted with an acid anhydride.

Examples of the aldehyde used here include formaldehyde, acetaldehyde, propionaldehyde, butyraldehyde, pentylaldehyde, hexylaldehyde, glyoxylic acid, N,N-dimethylformamide di-n-butyl acetal, bromoacetaldehyde, chloroacetaldehyde, 3-hydroxy-n-butyraldehyde, 3-methoxy-n-butyraldehyde, 3-(dimethylamino)-2,2-dimethylpropionaldehyde, and cyanoacetaldehyde, but the aldehyde is not limited thereto.

The acid content of the polyvinyl acetal resin that can be used in the present invention is preferably in the range of 0.5 to 5.0 meq/g (that is, 28 to 280 on a mg of KOH basis), and more preferably 1.0 to 3.0 meq/g.

Furthermore, the molecular weight of the polyvinyl acetal resin that can be used in the present invention is preferably 5,000 to 400,000 as a weight-average molecular weight measured by gel permeation chromatography, and more preferably 20,000 to 300,000. These polyvinyl acetal resins may be used singly or in a combination of two or more types.

The alkali-soluble resin used in the lower layer may be used singly or in a combination of two or more types.

In the multilayered photosensitive layer of the present invention, the content of the alkali-soluble resin in the uppermost layer relative to the total solids content is preferably 40 to 98 wt % from the viewpoint of sensitivity and durability of the photosensitive layer, and more preferably 60 to 97 wt %.

The content of the alkali-soluble resin in the lower layer components is preferably 40 to 95 wt % in the total solids content of the lower layer, and more preferably 50 to 90 wt %.

### Development Inhibitor

The photosensitive layer of the lithographic printing plate of the present invention may comprise a development inhibitor for the purpose of improving the inhibition (dissolution inhibition ability) thereof. It is particularly preferable to add a development inhibitor to the uppermost photosensitive layer.

The development inhibitor that can be used in the present invention is not particularly limited as long as it forms an interaction with the above-mentioned alkali-soluble resin, substantially degrades the solubility of the alkali-soluble resin in a developer in an unexposed area, and weakens the interaction in an exposed area and becomes soluble in the developer, and a quaternary ammonium salt, a polyethylene glycol compound, etc. are particularly preferably used. Furthermore, among photothermal conversion agents and image colorants, which will be described later, there are compounds that function as development inhibitors, and they can be cited as preferred examples.

The quaternary ammonium salt is not particularly limited, and examples thereof include a tetraalkylammonium salt, a trialkylarylammonium salt, a dialkyldiarylammonium salt, an alkyltriaryl ammonium salt, a tetraarylammonium salt, a cyclic ammonium salt, and a bicyclic ammonium salt.

Specific examples thereof include tetrabutylammonium bromide, tetrapentylammonium bromide, tetrahexylammonium bromide, tetraoctylammonium bromide, tetralaurylammonium bromide, tetraphenylammonium bromide, tetranaphthylammonium bromide, tetrabutylammonium chloride, tetrabutylammonium iodide, tetrastearylammonium bromide, lauryltrimethylammonium bromide, stearyltrimethylammonium bromide, behenyltrimethylammonium bromide, lauryltriethylammonium bromide, phenyltrimethylammonium bromide, 3-trifluoromethylphenyltrimethylammonium bromide, benzyltrimethylammonium bromide, dibenzyldimethylammonium bromide, distearyldimethylammonium bromide, tristearylmethylammonium bromide, benzyltriethylammonium bromide, hydroxyphenyltrimethylammonium bromide, and N-methylpyridinium bromide. Quaternary ammonium salts described in Japanese patent application Nos. 2001-226297, 2001-370059, and 2001-398047 are particularly preferable.

From the viewpoints of development inhibition effect and film formation properties of the alkali-soluble resin, the amount of quaternary ammonium salt added is preferably 0.1 to 50 wt % relative to the total solids content of the uppermost layer, and more preferably 1 to 30 wt %.

The polyethylene glycol compound is not particularly limited, and examples thereof include those having a structure represented by Formula (VI) below.

R⁶¹—{—O—(R⁶³—O—)ₘ—R⁶²}ₙ (VI)

In Formula (VI) above, R⁶¹ denotes a polyhydric alcohol residue or a polyhydric phenol residue, and R⁶² denotes a hydrogen atom or an optionally substituted alkyl group, alkenyl group, alkynyl group, alkyloyl group, aryl group, or aryloyl group having 1 to 25 carbons. R⁶³ denotes an optionally substituted alkylene residue, m is on average an integer of 10 or greater, and n denotes an integer of at least 1 but not greater than 4.

Examples of the polyethylene glycol compound represented by Formula (VI) above include a polyethylene glycol, a polypropylene glycol, a polyethylene glycol alkyl ether, a polypropylene glycol alkyl ether, a polyethylene glycol aryl ether, a polypropylene glycol aryl ether, a polyethylene glycol alkyl aryl ether, a polypropylene glycol alkyl aryl ether, a polyethylene glycol glycerol ether, a polypropylene glycol glycerol ether, a polyethylene glycol sorbitol ether, a polypropylene glycol sorbitol ether, a polyethylene glycol fatty acid ester, a polypropylene glycol fatty acid ester, a polyethylene glycolated ethylenediamine, a polypropylene glycolated ethylenediamine, a polyethylene glycolated diethylenetriamine, and a polypropylene glycolated diethylenetriamine.

Specific examples thereof include polyethylene glycol 1000, polyethylene glycol 2000, polyethylene glycol 4000, polyethylene glycol 10000, polyethylene glycol 20000, polyethylene glycol 5000, polyethylene glycol 100000, polyethylene glycol 200000, polyethylene glycol 500000, polypropylene glycol 1500, polypropylene glycol 3000, polypropylene glycol 4000, polyethylene glycol methyl ether, polyethylene glycol ethyl ether, polyethylene glycol phenyl ether, polyethylene glycol dimethyl ether, polyethylene glycol diethyl ether, polyethylene glycol diphenyl ether, polyethylene glycol lauryl ether, polyethylene glycol dilauryl ether, polyethylene glycol nonyl ether, polyethylene glycol cetyl ether, polyethylene glycol stearyl ether, polyethylene glycol distearyl ether, polyethylene glycol behenyl ether, polyethylene glycol dibehenyl ether, polypropylene glycol methyl ether, polypropylene glycol ethyl ether, polypropylene glycol phenyl ether, polypropylene glycol dimethyl ether, polypropylene glycol diethyl ether, polypropylene glycol diphenyl ether, polypropylene glycol lauryl ether, polypropylene glycol dilauryl ether, polypropylene glycol nonyl ether, polyethylene glycol acetyl ester, polyethylene glycol diacetyl ester, polyethylene glycol benzoate, polyethylene glycol lauryl ester, polyethylene glycol dilauryl ester, polyethylene glycol nonylate, polyethylene glycol cetylate, polyethylene glycol stearoyl ester, polyethylene glycol distearoyl ester, polyethylene glycol behenate, polyethylene glycol dibehenate, polypropylene glycol acetyl ester, polypropylene glycol diacetyl ester, polypropylene glycol benzoate, polypropylene glycol dibenzoate, polypropylene glycol laurylate, polypropylene glycol dilaurylate, polypropylene glycol nonylate, polyethylene glycol glycerol ether, polypropylene glycol glycerol ether, polyethylene glycol sorbitol ether, polypropylene glycol sorbitol ether, polyethylene glycolated ethylenediamine, polypropylene glycolated ethylenediamine, polyethylene glycolated diethylenetriamine, polypropylene glycolated diethylenetriamine, and polyethylene glycolated pentamethylenehexamine.

From the viewpoints of development inhibition effect and image formation properties, the amount of polyethylene glycol compound added is preferably 0.1 to 50 wt % relative to the total solids content of the uppermost layer, and more preferably 1 to 30 wt %.

Furthermore, when measures are taken to improve the inhibition (dissolution inhibition ability) in this way, the sensitivity is degraded, and as a countermeasure thereagainst adding a lactone compound described in JP-A-2002-361066 to the uppermost layer is effective for suppressing the degradation in sensitivity.

As the dissolution inhibitor it is preferable from the viewpoint of improvement in the inhibition of a developer in an image area to use, in addition to the above-mentioned compounds, an onium salt, an o-quinonediazide compound, an aromatic sulfone compound, or an aromatic sulfonic acid ester, etc., which are thermally decomposable but which in an undecomposed state substantially decrease the solubility of the alkali-soluble resin.

Examples of the onium salt used in the present invention include a diazonium salt, an ammonium salt, a phosphonium salt, an iodonium salt, a sulfonium salt, a selenonium salt, and an arsonium salt, and preferred examples thereof include diazonium salts described in, for example, S. I. Schlesinger, Photogr. Sci. Eng., 18, 387 (1974), T. S. Bal et al., Polymer, 21, 423 (1980), and JP-A-5-158230, ammonium salts described in U.S. Pat. Nos. 4,069,055 and 4,069,056, and JP-A-3-140140, phosphonium salts described in D. C. Necker et al., Macromolecules, 17, 2468 (1984), C. S. Wen et al., Tech. Proc. Conf. Rad. Curing ASIA, p. 478, Tokyo, October (1988), and U.S. Pat. Nos. 4,069,055 and 4,069,056, iodonium salts described in J. V. Crivello et al., Macromolecules, 10 (6), 1307 (1977), Chem. & Eng. News, November 28, p. 31 (1988), European Patent No. 104,143, U.S. Pat. Nos. 5,041,358 and 4,491,628, JP-A-2-150848, and JP-A-2-296514, sulfonium salts described in J. V. Crivello et al., Polymer J. 17, 73 (1985), J. V. Crivello et al., J. Org. Chem., 43, 3055 (1978), W. R. Watt et al., J. Polymer Sci., Polymer Chem Ed., 22, 1789 (1984), J. V. Crivello et al., Polymer Bull., 14, 279 (1985), J. V. Crivello et al., Macromolecules, 14(5), 1141 (1981), J. V. Crivello et al., J. Polymer Sci., Polymer Chem. Ed., 17, 2877 (1979), European Patent Nos. 370,693, 233,567, 297,443, and 297,442, U.S. Pat. Nos. 4,933,377, 3,902,114, 4,491,628, 4,760,013, 4,734,444, and 2,833,827, and German Patent Nos. 2,904,626, 3,604,580, and 3,604,581, selenonium salts described in J. V. Crivello et al., Macromolecules, 10 (6), 1307 (1977), and J. V. Crivello et al., J. Polymer Sci., Polymer Chem. Ed., 17, 1047 (1979), and arsonium salts described in C. S. Wen et al., Tech. Proc. Conf. Rad. Curing ASIA, p. 478 Tokyo, October (1988).

Among these onium salts, the diazonium salts are preferred. Particularly preferred diazonium salts are those described in JP-A-5-158230.

Examples of counter ions in the onium salts include anions from tetrafluoroboric acid, hexafluorophosphoric acid, triisopropylnaphthalenesulfonic acid, 5-nitro-o-toluenesulfonic acid, 5-sulfosalicylic acid, 2,5-dimethylbenzenesulfonic acid, 2,4,6-trimethylbenzenesulfonic acid, 2-nitrobenzenesulfonic acid, 3-chlorobenzenesulfonic acid, 3-bromobenzenesulfonic acid, 2-fluorocaprylnaphthalenesulfonic acid, dodecylbenzenesulfonic acid, 1-naphthol-5-sulfonic acid, 2-methoxy-4-hydroxy-5-benzoylbenzenesulfonic acid, p-toluenesulfonic acid, etc. Among these acids, anions from hexafluorophosphoric acid, and alkyl aromatic sulfonic acids such as triisopropylnaphthalenesulfonic acid and 2,5-dimethylbenzenesulfonic acid are suitable.

Suitable quinonediazides include o-quinonediazide compounds. The o-quinonediazides used in the present invention are compounds that have at least one o-quinonediazide group and that have increased alkali solubility by virtue of thermal decomposition, and such compounds having various structures can be used. That is, the o-quinonediazides have both the effect of losing the inhibition as a development inhibitor and the effect of allowing the o-quinonediazide itself to turn into an alkali-soluble substance by thermal decomposition, thus promoting the solubility of the uppermost layer.

As such o-quinonediazide compounds, for example, compounds described in J. Kosar, “Light-Sensitive Systems” p. 339-352, John Wiley & Sons, Inc. may be used, and sulfonic acid esters or sulfonamides of o-quinonediazides that have been reacted with various aromatic polyhydroxy compounds or aromatic amino compounds are particularly suitable. Esters of pyrogallol-acetone resins with benzoquinone-(1,2)-diazidosulfonyl chloride or naphthoquinone-(1,2)-diazido-5-suflonyl chloride described in JP-B-43-28403 and esters of phenol-formaldehyde resins with benzoquinone-(1,2)-diazidosulfonyl chloride or naphthoquinone-(1,2)-diazido-5-sulfonyl chloride described in U.S. Pat. Nos. 3,046,120 and 3,188,210 are also suitably used.

Furthermore, an ester of naphthoquinone-(1,2)-diazido-4-sulfonyl chloride with a phenol-formaldehyde resin or a cresol-formaldehyde resin, and an ester of naphthoquinone-(1,2)-diazido-4-sulfonyl chloride with a pyrogallol-acetone resin also are suitably used.

Other useful o-quinonediazide compounds are disclosed in a number of patents and are known. There can be cited, for example, those described in the specifications of JP-A-47-5303, JP-A-48-63802, JP-A-48-63803, JP-A-48-96575, JP-A-49-38701, JP-A-48-13354, JP-B-41-11222, JP-B-45-9610, JP-B-49-17481, U.S. Pat. Nos. 2,797,213, 3,454,400, 3,544,323, 3,573,917, 3,674,495, and 3,785,825, British Patent Nos. 1,227,602, 1,251,345, 1,267,005, 1,329,888, and 1,330,932, German Patent 854,890, etc.

The amount of o-quinonediazide compound added relative to the total solids content of the uppermost layer is preferably in the range of from 1 to 50 wt %, more preferably from 5 to 30 wt %, and particularly preferably from 10 to 30 wt %. These compounds can be used singly or as a mixture of several thereof.

In order to strengthen the inhibition of the surface of the photosensitive layer and strengthen the resistance to scratching of the surface, it is preferable to use in combination a polymer having as a polymerization component a (meth)acrylate monomer containing 2 or 3 perfluoroalkyl groups and having 3 to 20 carbon atoms in the molecule described in JP-A-2000-187318.

The amount of polymer added relative to the total solids content of the uppermost layer is preferably from 0.1 to 10 wt %, and more preferably from 0.5 to 5 wt %.

### Photothermal Conversion Agent

The infrared-sensitive lithographic printing plate of the present invention preferably comprises a photothermal conversion agent in the recording layer, more preferably comprises a photothermal conversion agent in at least one of the lower layer and the uppermost layer of the recording layer, and yet more preferably comprises it in both the lower layer and the uppermost layer.

The photothermal conversion agent is not particularly limited as long as it is a material that absorbs light and converts it to heat, but a dye that absorbs infrared or near-infrared rays and generates heat, that is, an infrared-absorbing agent, is preferable, and an infrared-absorbing agent that absorbs infrared rays and generates heat is more preferable.

As the photothermal conversion agent that can be used in the present invention, commercially available dyes and known dyes described in the literature (e.g., ‘Senryo Binran’ (Dye Handbook), edited by The Society of Synthetic Organic Chemistry, Japan, 1970) can be used. Specific examples of such dyes include azo dyes, metal complex azo dyes, pyrazolone azo dyes, anthraquinone dyes, phthalocyanine dyes, carbonium dyes, quinoneimine dyes, methine dyes, cyanine dyes, etc. In the present invention, among these dyes, an infrared-absorbing agent that absorbs infrared or near-infrared rays is particularly preferable from the viewpoint of use with lasers emitting infrared or near-infrared rays.

Examples of dyes absorbing infrared or near-infrared rays include cyanine dyes described in JP-A-58-125246, JP-A-59-84356, JP-A-60-78787, U.S. Pat. No. 4,973,572, etc., methine dyes described in JP-A-58-173696, JP-A-58-181690, JP-A-58-194595, etc., naphthoquinone dyes described in JP-A-58-112793, JP-A-58-224793, JP-A-59-48187, JP-A-59-73996, JP-A-60-52940, JP-A-60-63744, etc., squarylium dyes described in JP-A-58-112792 etc., and cyanine dyes described in British Patent No. 434,875, etc.

Furthermore, as the dyes, there can also be appropriately used near-infrared-absorbing sensitizers described in U.S. Pat. No. 5,156,938 and, moreover, substituted arylbenzo(thio)pyrylium salts described in U.S. Pat. No. 3,881,924, trimethinethiapyrylium salts described in JP-A-57-142645 (U.S. Pat. No. 4,327,169), pyrylium compounds described in JP-A-58-181051, JP-A-58-220143, JP-A-59-41363, JP-A-59-84248, JP-A-59-84249, JP-A-59-146063, and JP-A-59-146061, cyanine dyes described in JP-A-59-216146, pentamethinethiopyrylium salts, etc. described in U.S. Pat. No. 4,283,475, and pyrylium compounds, etc. as disclosed in JP-B-5-13514 and JP-B-5-19702, and as commercially available products, Epolight 111-178, Epolight 111-130, Epolight 111-125, etc. manufactured by Epolin, Inc. are particularly preferably used.

Furthermore, other examples of particularly preferred dyes include near-infrared-absorbing dyes denoted by Formulae (I) and (II) in U.S. Pat. No. 4,756,993.

It is preferable to add these photothermal conversion agents to the uppermost layer of the photosensitive layer or the vicinity thereof from the viewpoint of sensitivity. In particular, adding one having a dissolution inhibition capability such as a cyanine dye together with the alkali-soluble resin having a phenol group enables a high sensitivity to be achieved and, at the same time, alkali dissolution resistance to be imparted to an unexposed area. Furthermore, these photothermal conversion agents may be added to the lower layer or to both the upper layer and the lower layer. Adding one also to the lower layer enables higher sensitivity to be achieved. When the photothermal conversion agent is added to both the uppermost layer and the lower layer, the two layers may employ the same compound or different compounds.

When added to the uppermost layer of the recording layer, the amount of photothermal conversion agent added is preferably 0.01 to 50 wt % relative to the total solids content of the uppermost layer, more preferably 0.1 to 30 wt %, and particularly preferably 1.0 to 30 wt %. By setting the amount thereof added in the above-mentioned range, the sensitivity and durability of the recording layer are improved.

Furthermore, when added to the lower layer, it may be added preferably at a proportion of 0 to 20 wt % relative to the total solids content of the lower layer, more preferably 0 to 10 wt %, and particularly preferably 0 to 5 wt %. When the photothermal conversion agent is added to the lower layer, use of a photothermal conversion agent having a dissolution inhibition capability degrades the solubility of the lower layer, but since it is expected that the solubility of the lower layer would be improved by heat generated when the photothermal conversion agent is exposed to an infrared laser, the compound added and the amount thereof added should be selected while taking into consideration the balance between the above points. In addition, in a region in the vicinity of, that is, 0.2 to 0.3 μm from a support, since heat generated during exposure diffuses to the support, it is difficult to obtain the effect from the heat in improving solubility, and degradation in the solubility of the lower layer due to the addition of an infrared-absorbing dye might become the main cause of degradation of the sensitivity. Therefore, even in the above-mentioned range for the amount thereof added, an amount that makes the dissolution rate of the lower layer in a developer (25 to 30° C.) less than 30 nm/sec is not desirable.

### Long Chain Alkyl Group-Containing Polymer

The recording layer of the infrared-sensitive lithographic printing plate of the present invention preferably comprises a long chain alkyl group-containing polymer.

The long chain alkyl group-containing polymer that can be used in the present invention preferably comprises a carboxy group-containing vinyl monomer in a compositional ratio range of 45 to 99 mol %. The long chain alkyl group in the long chain alkyl group-containing polymer denotes one having at least 6 carbons, and preferably at least 12 carbons. More specifically, the long chain alkyl group-containing polymer is preferably a copolymer of a monomer having a long chain alkyl group and a carboxy group-containing vinyl monomer, and is a polymer comprising the carboxy group-containing vinyl monomer in a compositional ratio range of 45 to 99 mol %.

In the present invention, the long chain alkyl group-containing polymer preferably comprises, for example, a copolymer represented by Formula (VII) below.

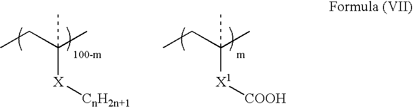

In Formula (VII), X and X′ independently denote a single bond or a divalent linking group. m denotes an integer of 45<m<99, preferably an integer of 47<m<95, and more preferably an integer of 50<m<90. n denotes an integer of 6 to 40, preferably an integer of 12 to 30, and more preferably an integer of 14 to 20. A bond shown by a dotted line means that there is a methyl group or hydrogen at its end.

Specific examples of the divalent linking group denoted by X and X′ in Formula (VII) include a straight-chain, branched, or cyclic alkylene group having 1 to 20 carbons, a straight-chain, branched, or cyclic alkenylene group having 2 to 20 carbons, an alkynylene group having 2 to 20 carbons, an arylene group (monocyclic, heterocyclic) having 6 to 20 carbons, —OC(═O)—, —OC(═O)Ar—, —OC(═O)O—, —OC(═O)OAr—, —C(═O)NR—, —C(═O)NAr—, —SO₂NR—, —SO₂NAr—, —O— (alkyleneoxy, polyalkyleneoxy), —OAr— (aryleneoxy, polyaryleneoxy), —C(═O)O—, —C(═O)O—Ar—, —C(═O)Ar—, —C(═O)—, —SO₂O—, —SO₂OAr—, —OSO₂—, —OSO₂Ar—, —NRSO₂—, —NArSO₂—, —NRC(═O)—, —NArC(═O)—, —NRC(═O)O—, —NArC(═O)O—, —OC(═O)NR—, —OC(═O)NAr—, —NAr—, —NR—, —N⁺RR′—, —N⁺RAr—, —N⁺ArAr′—, —S—, —SAr—, —ArS—, a heterocyclic group (a 3- to 12-membered monocyclic or condensed ring containing as a hetero atom, for example, at least one of nitrogen, oxygen, sulfur, etc.), —OC(═S)—, —OC(═S)Ar—, —C(═S)O—, —C(═S)OAr—, —C(═S)OAr—, —C(═O)S—, —C(═O)SAr—, —ArC(═O)—, —ArC(═O)NR—, —ArC(═O)NAr—, —ArC(═O)O—, —ArC(═O)S—, —ArC(═S)O—, —ArO—, and —ArNR—. Here, R and R′ independently denote a hydrogen atom or a straight-chain, branched, or cyclic alkyl group, alkenyl group, or alkynyl group. Ar and Ar′ independently denote an aryl group or an arylene group.

The above-mentioned linking group may be a linking group formed by a combination of two or more types of the linking groups cited here.

Among such linking groups, an arylene group (monocyclic, heterocyclic) having 6 to 20 carbons, —C(═O)NR—, —C(═O)NAr—, —O— (alkyleneoxy, polyalkyleneoxy), —OAr— (aryleneoxy, polyaryleneoxy), —C(═O)O—, —C(═O)O—Ar—, —C(═O)—, —C(═O)Ar—, —S—, —SAr—, —ArS—, —ArC(═O)—, —ArC(═O)O—, —ArO—, —ArNR—, etc. are preferable, and an arylene group (monocyclic, heterocyclic) having 6 to 20 carbons, —C(═O)NR—, —C(═O)NAr—, —O— (alkyleneoxy, polyalkyleneoxy), —OAr— (aryleneoxy, polyaryleneoxy), —C(═O)O—, —C(═O)O—Ar—, —SAr—, —ArS—, —ArC(═O)—, —ArC(═O)O—, —ArO—, —ArNR—, etc. are more preferable.

Furthermore, the above-mentioned linking group may have a substituent, and examples of the substituent include a straight-chain, branched, or cyclic alkyl group having 1 to 20 carbons, a straight-chain, branched, or cyclic alkenyl group having 2 to 20 carbons, an alkynyl group having 2 to 20 carbons, an aryl group having 6 to 20 carbons, an acyloxy group having 1 to 20 carbons, an alkoxycarbonyloxy group having 2 to 20 carbons, an aryloxycarbonyloxy group having 7 to 20 carbons, a carbamoyloxy group having 1 to 20 carbons, a carbonamide group having 1 to 20 carbons, a sulfonamide group having 1 to 20 carbons, a carbamoyl group having 1 to 20 carbons, a sulfamoyl group having 0 to 20 carbons, an alkoxy group having 1 to 20 carbons, an aryloxy group having 6 to 20 carbons, an aryloxycarbonyl group having 7 to 20 carbons, an alkoxycarbonyl group having 2 to 20 carbons, an N-acylsulfamoyl group having 1 to 20 carbons, an N-sulfamoylcarbamoyl group having 1 to 20 carbons, an alkylsulfonyl group having 1 to 20 carbons, an arylsulfonyl group having 6 to 20 carbons, an alkoxycarbonylamino group having 2 to 20 carbons, an aryloxycarbonylamino group having 7 to 20 carbons, an amino group having 0 to 20 carbons, an imino group having 1 to 20 carbons, an ammonio group having 3 to 20 carbons, a carboxy group, a sulfo group, an oxy group, a mercapto group, an alkylsulfinyl group having 1 to 20 carbons, an arylsulfinyl group having 6 to 20 carbons, an alkylthio group having 1 to 20 carbons, an arylthio group having 6 to 20 carbons, a ureido group having 1 to 20 carbons, a heterocyclic group having 2 to 20 carbons, an acyl group having 1 to 20 carbons, a sulfamoylamino group having 0 to 20 carbons, a silyl group having 2 to 20 carbons, a hydroxy group, a halogen atom (e.g. a fluorine atom, a chlorine atom, a bromine atom, etc.), a cyano group, and a nitro group.

In the present invention, the long chain alkyl group-containing polymer preferably comprises, for example, an acrylic copolymer represented by Formula (VIII) below.

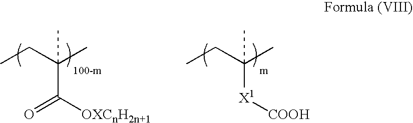

In Formula (VIII), X and X′ independently denote a single bond or a divalent linking group. Such groups denoted by X and X′ in Formula (VIII) are the same as those denoted by X and X′ in Formula (VII) above, and preferred examples are also the same. m denotes an integer of 45<m<99, preferably an integer of 47<m<95, and more preferably an integer of 50<m<90. n denotes an integer of 6 to 40, preferably an integer of 12 to 30, and more preferably an integer of 14 to 20. A bond shown by a dotted line means that there is a methyl group or hydrogen at its end.

Furthermore, in the present invention, the long chain alkyl group-containing polymer more preferably comprises, for example, an acrylic copolymer represented by Formula (IX) below.

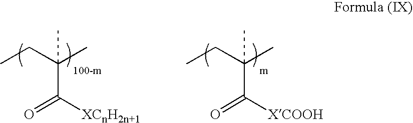

In Formula (IX), X and X′ independently denote a single bond or a divalent linking group. Such groups denoted by X and X′ in Formula (IX) are the same as those denoted by X and X′ in Formula (VII) above, and preferred examples are also the same. m denotes an integer of 45<m<99, preferably an integer of 47<m<95, and more preferably an integer of 50<m<90. n denotes an integer of 6 to 40, preferably an integer of 12 to 30, and more preferably an integer of 14 to 20. A bond shown by a dotted line means that there is a methyl group or hydrogen at its end.

Moreover, in the present invention, the long chain alkyl group-containing polymer most preferably comprises, for example, an acrylic copolymer represented by Formula (X) or Formula (XI) below.

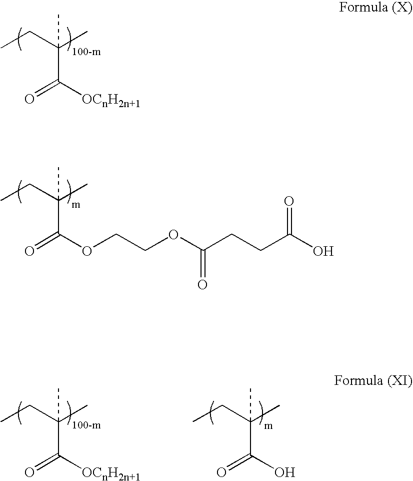

In Formula (X) and Formula (XI), m denotes an integer of 45<m<99, preferably an integer of 47<m<95, and more preferably an integer of 50<m<90. n denotes an integer of 6 to 40, preferably an integer of 12 to 30, and more preferably an integer of 14 to 20. A bond shown by a dotted line means that there is a methyl group or hydrogen at its end.

Furthermore, the long chain alkyl group-containing polymer that can be used in the present invention most preferably comprises an acrylic copolymer represented by Formula (XI) from the viewpoint of a balance between scratch resistance and alkali solubility.

The long chain alkyl group-containing polymer that can be used in the present invention may be a copolymer with, in addition to the monomer having a long chain alkyl group or the vinyl monomer having a carboxy group, at least one type of monomer selected from a hydrophilic monomer and other monomers shown below. In this case, the molar proportion of the other monomer in the copolymer is preferably 40 mol % or less, more preferably 30 mol % or less, and yet more preferably 25 mol % or less, from the viewpoint of the formation of surface micro projections.

### Other Additives

When forming the recording layer, in addition to the above-mentioned components, various additives may be added as necessary as long as the effects of the present invention are not impaired. The additives cited below may be added only to the lower layer of the recording layer, only to the uppermost layer, or to both layers.

### Development Accelerator

For the purpose of improving the sensitivity, an acid anhydride, a phenol, or an organic acid may be added to the recording layer in the present invention.

The acid anhydride is preferably a cyclic acid anhydride, and specific examples thereof, described in U.S. Pat. No. 4,115,128, include phthalic anhydride, tetrahydrophthalic anhydride, hexahydrophthalic anhydride, 3,6-endooxytetrahydrophthalic anhydride, tetrachlorophthalic anhydride, maleic anhydride, chloromaleic anhydride, α-phenylmaleic anhydride, succinic anhydride, pyrromellitic anhydride, etc. As a noncyclic acid anhydride, acetic anhydride can be cited.

Examples of the phenol include bisphenol A, 2,2-bishydroxysulfone, 4,4-bishydroxysulfone, p-nitrophenol, p-ethoxyphenol, 2,4,4′-trihydoxybenzophenone, 2,3,4-trihydroxybenzophenone, 4-hydroxybenzophenone, 4,4′,4″-trihydroxytriphenylmethane, 4,4′,3″,4″-tetrahydroxy-3,5,3′,5′-tetramethyltriphenylmethane, etc.

Examples of the organic acid include sulfonic acids, sulfinic acids, alkylsulfuric acids, phosphonic acids, phosphoric acid esters, carboxylic acids, etc. described in JP-A-60-88942, JP-A-2-96755, etc., and specifically p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid, and ascorbic acid.

The amounts of the acid anhydride, phenol, or organic acid added are preferably 0.05 to 20 wt % each, more preferably 0.1 to 15 wt %, and particularly preferably 0.1 to 10 wt %, relative to the total solids content of the lower layer or the uppermost layer of the photosensitive layer.

### Surfactant

For the purpose of improving the coating properties and enhancing the stability to treatment under development conditions, the recording layer of the present invention may contain a nonionic surfactant described in JP-A-62-251740 and JP-A-3-208514, an amphoteric surfactant described in JP-A-59-121044 and JP-A-4-13149, a siloxane compound described in European Patent No. 950,517, and a copolymer of fluorine-containing monomers described in JP-A-62-170950, JP-A-11-288093, and JP-A-2003-057820.

The amount of surfactant added is preferably 0.01 to 15 wt %, more preferably 0.1 to 5.0 wt %, and further preferably 0.05 to 2.0 wt %, relative to the total solids content of the lower layer or the uppermost layer of the recording layer.

### Printing-Out Agent/Colorant

The recording layer of the present invention may contain a dye or a pigment as a printing-out agent or an image colorant to immediately form a visible image after the heating caused by exposure.

As a representative example of the printing-out agent, there can be cited a combination of a compound releasing an acid as a result of the heating caused by exposure (photo-acid generator) and a salt-forming organic dye. Specific examples of the agent include a combination of an o-naphthoquinonediazido-4-sulfonic halide and a salt-forming organic dye described in JP-A-50-36209 and JP-A-53-8128 and a combination of a trihalomethyl compound and a salt-forming organic dye described in JP-A-53-36223, JP-A-54-74728, JP-A-60-3626, JP-A-61-143748, JP-A-61-151644, and JP-A-63-58440. Such trihalomethyl compounds include oxazole compounds and triazine compounds, which both have excellent aging stability and give clear printed-out images.

In addition to the above-mentioned salt-forming organic dyes, another dye may be used as the image colorant. As well as the salt-forming organic dyes, oil-soluble dyes and basic dyes are suitable dyes. Specific examples of the image colorants include Oil Yellow #101, Oil Yellow #103, Oil Pink #312, Oil Green BG, Oil Blue BOS, Oil Blue #603, Oil Black BY, Oil Black BS, Oil Black T-505 (the above dyes are manufactured by Orient Kagaku Kogyo K. K.), Victoria Pure Blue, Crystal Violet Lactone, Crystal Violet (CI42555), Methyl Violet (CI42535), Ethyl Violet, Rhodamine B (CI145170B), Malachite Green (CI42000), Methylene Blue (CI52015), etc. Moreover, dyes described in JP-A-62-293247 are particularly preferred.

These dyes are added preferably at 0.01 to 10 wt %, and more preferably 0.1 to 3 wt %, relative to the total solids content of the lower layer or the uppermost layer of the photosensitive layer.

### Plasticizer

A plasticizer may be added to the recording layer of the present invention in order to impart flexibility to the coating. Examples of the plasticizer used include butylphthalyl butyl glycolate, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl oleate, and oligomers and polymers of acrylic acid or methacrylic acid.

The plasticizer may be added preferably at 0.5 to 10 wt %, and more preferably 1.0 to 5.0 wt %, relative to the total solids content of the lower layer or the uppermost layer of the layer.

### Wax Agent

For the purpose of imparting resistance to scratching, a compound that reduces the coefficient of static friction of the surface may be added to the single recording layer or the uppermost layer of the multiple layers of the present invention. Specific examples thereof include a compound having an ester of a long chain alkylcarboxylic acid such as those described in U.S. Pat. No. 6,117,913, and Japanese patent application Nos. 2001-261627, 2002-032904, and 2002-165584, which have been filed by the present applicant. The amount thereof added as the proportion in the uppermost layer of the photosensitive layer is preferably 0.1 to 10 wt %, and more preferably 0.5 to 5 wt %.

### Formation of Recording Layer

The recording layer of the infrared-sensitive lithographic printing plate of the present invention may be formed by applying a solution of the above-mentioned components in a solvent.

Examples of the solvent used here include ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethylsulfoxide, sulfolane, γ-butyrolactone, and toluene, but the solvent is not limited to these solvents. These solvents can be used singly or as a mixture of two or more thereof.

In principle, it is preferable to form the lower layer and the uppermost layer of the recording layer as two separate layers.

With regard to a method for forming two layers separately, for example, there is a method in which a difference in solvent solubility between components contained in the lower layer and components contained in the uppermost layer is utilized, or a method in which after the uppermost layer is applied, the solvent is rapidly dried and removed.

Details of these methods are described in JP-A-2002-251003.

In order to impart a novel function, the uppermost layer and the lower layer might actively be made partially miscible with each other as long as the effects of the present invention are sufficiently exhibited. In this case, the partial miscibility is possible by controlling a difference in solvent solubility, the drying speed of the solvent after the uppermost layer is applied, etc.

The concentration of the above-mentioned components excluding the solvent (total solids content, including additives) in the recording layer coating solution applied to a support is preferably 1 to 50 wt %.

With regard to a coating method, various methods can be employed, and examples thereof include a bar coating method, a rotary coating method, a spray coating method, a curtain coating method, a dip coating method, an air-knife coating method, a blade coating method, and a roll coating method.

In particular, in a multi-layer system, in order to prevent any damage to the lower layer when applying the uppermost layer, it is preferable for the Uppermost layer to be applied by a non-contact type coating method. Although it is possible to employ a bar coating method as a generally used method for solvent-based coating even though it is a contact type, it is desirable that coating is carried out by direct roll coating in order to prevent damage to the lower layer.

The dry coat weight of the recording layer lower layer components applied on a support of the infrared-sensitive lithographic printing plate of the present invention is preferably in the range of 0.5 to 4.0 g/m², and more preferably in the range of 0.6 to 2.5 g/m². When it is at least 0.5 g/m², the plate life is excellent, and when it is not greater than 4.0 g/m², good image reproducibility and sensitivity can be obtained.

Furthermore, the dry coat weight of the recording layer uppermost layer components is preferably in the range of 0.05 to 1.0 g/m², and more preferably in the range of 0.08 to 0.7 g/m². When it is at least 0.05 g/m², good development latitude and scratch resistance can be obtained, and when it is not greater than 1.0 g/m², good sensitivity can be obtained.

The combined dry coat weight of the recording layer lower layer and uppermost layer is preferably in the range of 0.6 to 4.0 g/m², and more preferably in the range of 0.7 to 2.5 g/m². When it is at least 0.6 g/m², good plate life can be obtained, and when it is not greater than 4.0 g/m², good image reproducibility and sensitivity can be obtained.

### Support

With regard to a support used for the infrared-sensitive lithographic printing plate of the present invention, it is not particularly limited as long as it is a sheet-form material that has required strength and durability and is dimensionally stable; examples thereof include paper, paper laminated with a plastic (for example, polyethylene, polypropylene, or polystyrene), a metal sheet (for example, aluminum, zinc, or copper), a plastic film (for example, cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, or polyvinyl acetal), paper laminated with the above-mentioned metal or having the above-mentioned metal vapor-deposited thereon, and a plastic film.

Among them, polyester film and aluminum sheet are preferable in the present invention, and aluminum sheet is particularly preferable thereamong because of its good dimensional stability and relatively low cost. Preferred examples of the aluminum sheet include a pure aluminum sheet and an alloy sheet containing aluminum as a main component and also containing a small amount of another element, and it is also possible to use a plastic film laminated with aluminum or having aluminum vapor-deposited thereon. Examples of the other element contained in the aluminum alloy include silicon, iron, manganese, copper, magnesium, chromium, zinc, bismuth, nickel, and titanium. The content of the other element in the alloy is 10 wt % or less.

A particularly preferred aluminum in the present invention is pure aluminum, but since it is difficult to produce completely pure aluminum from the standpoint of refining technology, a trace amount of another element may be present.

As described above, the composition of the aluminum sheet employed in the present invention is not specified, and a conventionally known and used aluminum sheet material can be used as appropriate. The thickness of the aluminum sheet used in the present invention is preferably 0.1 to 0.6 mm, more preferably 0.15 to 0.4 mm, and particularly preferably 0.2 to 0.3 mm.

Such an aluminum sheet may be subjected to a surface treatment such as a surface roughening treatment or an anodizing treatment as necessary. Such surface treatments are briefly described below.

Prior to roughening the surface of the aluminum sheet, if desired, a degreasing treatment with, for example, a surfactant, an organic solvent, or an aqueous alkaline solution is carried out in order to remove a rolling oil from the surface. The roughening treatment of the surface of the aluminum sheet may be carried out by various methods such as, for example, a method involving mechanical roughening, a method involving electrochemical dissolution-roughening of the surface, and a method involving selective chemical dissolution of the surface. With regard to the mechanical method, a known method can be employed such as a ball grinding method, a brush grinding method, a blast grinding method, or a buff grinding method. With regard to the electrochemical roughening method, there is a method in which alternating current or direct current is used in a hydrochloric acid or nitric acid electrolytic solution. As disclosed in JP-A-54-63902, a method in which the two are combined can also be employed.

The aluminum sheet whose surface has been thus roughened is subjected to an alkali etching treatment and a neutralization treatment as necessary and then, if desired, to an anodizing treatment in order to improve the water retention and the abrasion resistance of the surface. With regard to an electrolyte used for the anodizing treatment of the aluminum sheet, various electrolytes for forming a porous oxide coating can be used and, in general, sulfuric acid, phosphoric acid, oxalic acid, chromic acid, or a mixture of these acids is used. The concentration of the electrolyte is determined according to the type of electrolyte as appropriate.

The conditions for the anodizing treatment depend on the type of electrolyte used and cannot, as a rule, be fixed but, in general, an electrolyte solution concentration of 1 to 80 wt %, a solution temperature of 5° C. to 70° C., a current density of 5 to 60 A/dm², a voltage of 1 to 100 V, and an electrolysis time of 10 sec to 5 min are appropriate. It is preferable for the amount of anodized coating to be 1.0 g/m² or greater since the plate life is sufficient, the non-image areas of the lithographic printing plate become resistant to scratching, and there is hardly any of the so-called ‘scratch staining’, which is caused by ink becoming attached to scratched areas during printing.

After being subjected to the anodizing treatment, the surface of the aluminum is subjected as necessary to a treatment to hydrophilize the surface.

With regard to the hydrophilization treatment employed in the present invention, there are methods employing an alkali metal silicate (for example, an aqueous solution of sodium silicate) as disclosed in U.S. Pat. Nos. 2,714,066, 3,181,461, 3,280,734, and 3,902,734. In these methods, the support is subjected to an immersion treatment or to an electrolysis treatment in an aqueous solution of sodium silicate. It is also possible to employ a method involving treatment with potassium fluorozirconate as disclosed in JP-B-36-22063, or with polyvinylphosphonic acid as disclosed in U.S. Pat. Nos. 3,276,868, 4,153,461, and 4,689,272.

### Undercoat Layer

The infrared-sensitive lithographic printing plate of the present invention may be provided with an undercoat layer (hereinafter, also called an ‘organic undercoat layer’) between the support and the recording layer as necessary.

The undercoat layer of the present invention preferably comprises a polymer having a side chain structure represented by Formula (1) below (specific polymer).

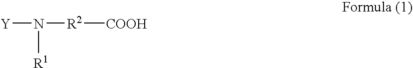

(In Formula (1), Y denotes a linking group to a polymer main chain skeleton. R¹ denotes a hydrogen atom or a hydrocarbon group. R² denotes a divalent hydrocarbon group.)

In Formula (1), Y denotes a linking group to a polymer main chain skeleton. Examples of the linking group denoted by Y include a substituted or unsubstituted divalent hydrocarbon group. The hydrocarbon group may have at least one partial structure containing at least one hetero atom selected from the group consisting of an oxygen atom, a nitrogen atom, and a sulfur atom.

In Formula (1), R¹ denotes a hydrogen atom or a hydrocarbon group.

The hydrocarbon group denoted by R¹ is preferably a hydrocarbon group having 1 to 30 carbons. Among such hydrocarbon groups, it is preferably an alkyl group or an aryl group.

The hydrocarbon group denoted by R¹ may have a substituent, which will be described later, and the substituent is particularly preferably a carboxyl group or a group comprising a salt thereof.

The hydrocarbon group denoted by R¹ is most preferably an alkyl group or aryl group having a carboxyl group, or a group comprising a salt thereof.

The hydrocarbon group denoted by R¹ and the substituent that can be introduced into the hydrocarbon group are explained in detail.

Specific examples of the alkyl group denoted by R¹ include straight-chain, branched, or cyclic alkyl groups having 1 to 30 carbons such as a methyl group, an ethyl group, a propyl group, a butyl group, a pentyl group, a hexyl group, a heptyl group, an octyl group, a nonyl group, a decyl group, an undecyl group, a dodecyl group, a tridecyl group, a hexadecyl group, an octadecyl group, an eicosyl group, an isopropyl group, an isobutyl group, a sec-butyl group, a tert-butyl group, an isopentyl group, a neopentyl group, a 1-methylbutyl group, an isohexyl group, a 2-ethylhexyl group, a 2-methylhexyl group, a cyclopentyl group, a cyclohexyl group, a 1-adamantyl group, and a 2-norbornyl group.

The aryl group denoted by R¹ includes one in which a condensed ring is formed from 2 to 4 benzene rings and one in which a condensed ring is formed from a benzene ring and an unsaturated 5-membered ring.

Specific examples of the aryl group denoted by R¹ include aryl groups having 6 to 30 carbons such as a phenyl group, a naphthyl group, an anthryl group, a phenanthryl group, an indenyl group, an acenaphthenyl group, a fluorenyl group, and a pyrenyl group.

The hydrocarbon group denoted by R¹ may be mono- or multi-substituted with any substituent. Examples of the substituent that can be introduced into R¹ include a monovalent non-metallic atomic group other than a hydrogen atom. Specific examples thereof include a halogen atom (—F, —Br, —Cl, —I), a hydroxyl group, an alkoxy group, an aryloxy group, a mercapto group, an alkylthio group, an arylthio group, an alkyldithio group, an aryldithio group, an amino group, an N-alkylamino group, an N,N-dialkylamino group, an N-arylamino group, an N,N-diarylamino group, an N-alkyl-N-arylamino group, an acyloxy group, a carbamoyloxy group, an N-alkylcarbamoyloxy group, an N-arylcarbamoyloxy group, an N,N-dialkylcarbamoyloxy group, an N,N-diarylcarbamoyloxy group, an N-alkyl-N-arylcarbamoyloxy group, an alkylsulfoxy group, an arylsulfoxy group, an acylthio group, an acylamino group, an N-alkylacylamino group, an N-arylacylamino group, a ureido group, an N′-alkylureido group, an N′,N′-dialkylureido group, an N′-arylureido group, an N,N′-diarylureido group, an N′-alkyl-N′-arylureido group, an N-alkylureido group, an N-arylureido group, an N′-alkyl-N-alkylureido group, an N′-alkyl-N-arylureido group, an N′,N′-dialkyl-N-alkylureido group, an N,N′-dialkyl-N-arylureido group, an N′-aryl-N-alkylureido group, an N′-aryl-N-arylureido group, an N′,N′-diaryl-N-alkylureido group, an N′,N′-diaryl-N-arylureido group,

an N′-alkyl-N′-aryl-N-alkylureido group, an N′-alkyl-N′-aryl-N-arylureido group, an alkoxycarbonylamino group, an aryloxycarbonylamino group, an N-alkyl-N-alkoxycarbonylamino group, an N-alkyl-N-aryloxycarbonylamino group, an N-aryl-N-alkoxycarbonylamino group, an N-aryl-N-aryloxycarbonylamino group, a formyl group, an acyl group, a carboxyl group and a group formed from a salt thereof, an alkoxycarbonyl group, an aryloxycarbonyl group, a carbamoyl group, an N-alkylcarbamoyl group, an N,N-dialkylcarbamoyl group, an N-arylcarbamoyl group, an N,N-diarylcarbamoyl group, an N-alkyl-N-arylcarbamoyl group, an alkylsulfinyl group, an arylsulfinyl group, an alkylsulfonyl group, an arylsulfonyl group, a sulfo group (—SO₃H) and a group formed from a salt thereof, an alkoxysulfonyl group, an aryloxysulfonyl group, a sulfinamoyl group, an N-alkylsulfinamoyl group, an N,N-dialkylsulfinamoyl group, an N-arylsulfinamoyl group, an N,N-diarylsulfinamoyl group, an N-alkyl-N-arylsulfinamoyl group, a sulfamoyl group, an N-alkylsulfamoyl group, an N,N-dialkylsulfamoyl group, an N-arylsulfamoyl group, an N,N-diarylsulfamoyl group, an N-alkyl-N-arylsulfamoyl group, an N-acylsulfamoyl group and a group formed from a salt thereof, an N-alkylsulfonylsulfamoyl group (—SO₂NHSO₂(alkyl)) and a group formed from a salt thereof, an N-arylsulfonylsulfamoyl group (—SO₂NHSO₂(aryl)) and a group formed from a salt thereof, an N-alkylsulfonylcarbamoyl group (—CONHSO₂(alkyl)) and a group formed from a salt thereof,

an N-arylsulfonylcarbamoyl group (—CONHSO₂(aryl)) and a group formed from a salt thereof, an alkoxysilyl group (—Si(Oalkyl)₃), an aryloxysilyl group (—Si(Oaryl)₃), a hydroxysilyl group (—Si(OH)₃) and a group formed from a salt thereof, a phosphono group (—PO₃H₂) and a group formed from a salt thereof, a dialkylphosphono group (—PO₃(alkyl)₂), a diarylphosphono group (—PO₃(aryl)₂), an alkylarylphosphono group (—PO₃(alkyl)(aryl)), a monoalkylphosphono group (—PO₃H(alkyl)) and a group formed from a salt thereof, a monoarylphosphono group (—PO₃H(aryl)) and a group formed from a salt thereof, a phosphonooxy group (—OPO₃H₂) and a group formed from a salt thereof, a dialkylphosphonooxy group (—OPO₃(alkyl)₂), a diarylphosphonooxy group (—OPO₃(aryl)₂), an alkylarylphosphonooxy group (—OPO₃(alkyl)(aryl)), a monoalkylphosphonooxy group (—OPO₂H(alkyl)) and a group formed from a salt thereof, a monoarylphosphonooxy group (—OPO₃H(aryl)) and a group formed from a salt thereof, a cyano group, a nitro group, an aryl group, an alkyl group, an alkenyl group, and an alkynyl group.

Among the above-mentioned substituents that can be introduced into R¹, a carboxyl group and a group formed from a salt thereof, an alkoxycarbonyl group, and an aryloxycarbonyl group are preferable, and a carboxyl group and a group formed from a salt thereof are particularly preferable.

In Formula (1), R² denotes a divalent hydrocarbon group, which may further have a substituent. This hydrocarbon group may contain 1 or more hetero atoms selected from the group consisting of an oxygen atom, a nitrogen atom, and a sulfur atom.

Examples of the substituent that can be introduced into R² include the same substituents shown as the substituent that can be introduced into R¹ above, and preferred substituents are also the same.

The divalent hydrocarbon group denoted by R² is more preferably an optionally substituted alkylene group or phenylene group. Specific examples thereof include a straight-chain or branched alkylene group such as a methylene group, an ethylene group, a propylene group, a butylene group, an isopropylene group, or an isobutylene group, and a phenylene group. As a more preferred example, one in which the above-mentioned alkylene group is substituted with a carboxylic acid group can be cited.

The carboxylic acid group in Formula (1) may form an alkali metal salt or an ammonium salt.

A preferred structure of Formula (1) is one in which R¹ is a hydrocarbon group substituted with a carboxylic acid group and R² is a straight-chain hydrocarbon group or a hydrocarbon group substituted with a carboxylic acid group. Furthermore, the most preferred structure of Formula (1) is a case in which R¹ is an alkyl group substituted with a carboxylic acid group and R² is a straight-chain alkylene group.

With regard to a method for introducing the structure represented by Formula (1) into a side chain of a polymer, for example, a monomer having the structure represented by Formula (1) is polymerized or copolymerized by a known method. Alternatively, there is a method in which a poly-p-aminostyrene and chloroacetic acid are reacted, or a method in which polychloromethylstyrene and iminodiacetonitrile are reacted and then hydrolyzed, etc. From the viewpoint of easily controlling the percentage introduction of the structure represented by Formula (1), the method in which a monomer having the structure represented by Formula (1) is polymerized or copolymerized by a known method is preferable.

When the specific polymer is a copolymer, it may be any of a random copolymer, a block copolymer, and a graft copolymer.

The specific polymer may be synthesized by radical polymerization employing a polymerization initiator such as, for example, a peroxide such as di-t-butyl peroxide or benzoyl peroxide, a persulfate such as ammonium persulfate, or an azo compound such as azobisisobutyronitrile. The polymerization initiator may be selected as appropriate depending on the polymerization method used. The polymerization method may employ solution polymerization, emulsion polymerization, suspension polymerization, etc.

Examples of a polymerization solvent used for synthesis include acetone, methyl ethyl ketone, methanol, ethanol, propanol, ethylene glycol monomethyl ether, ethylene glycol monoethyl ether, diethylene glycol dimethyl ether, 1-methoxy-2-propanol, 2-methoxyethyl acetate, 1-methoxy-2-propyl acetate, dimethoxyethane, methyl lactate, ethyl lactate, ethyl acetate, N,N-dimethylacetamide, N,N-dimethylformamide, dimethylsulfoxide, tetrahydrofuran, toluene, and water, but are not limited thereto.

Specific examples of the monomer having the structure represented by Formula (1) include the compounds below, but the present invention should not be construed as being limited thereto.

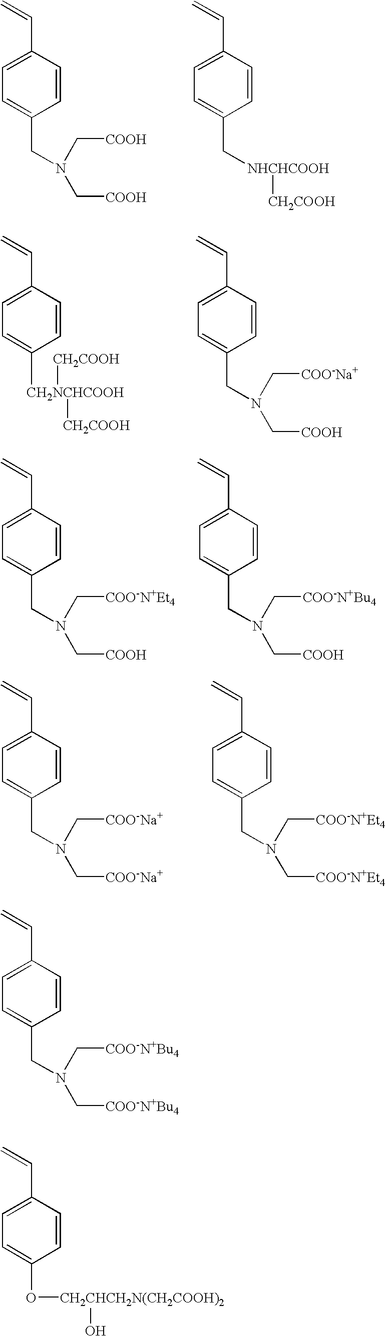

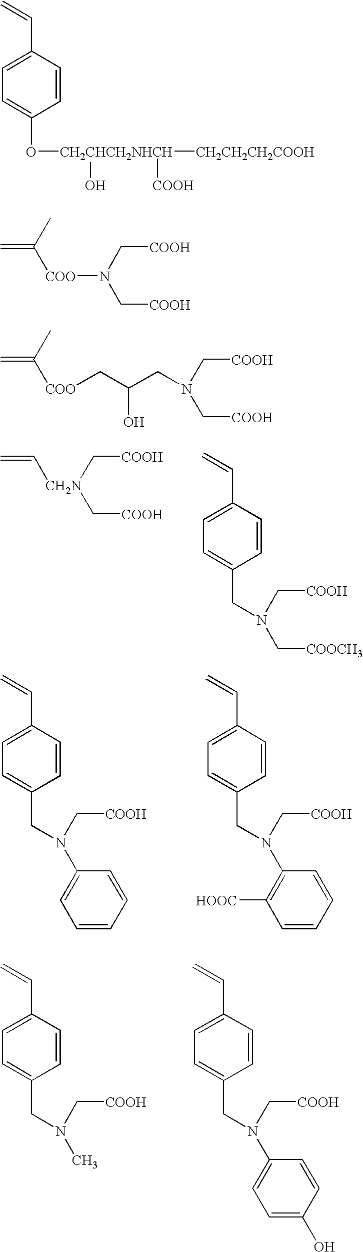

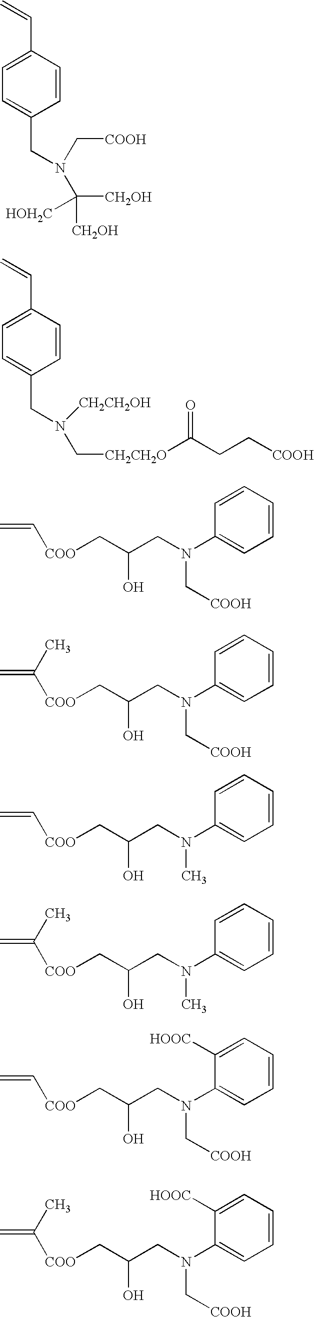

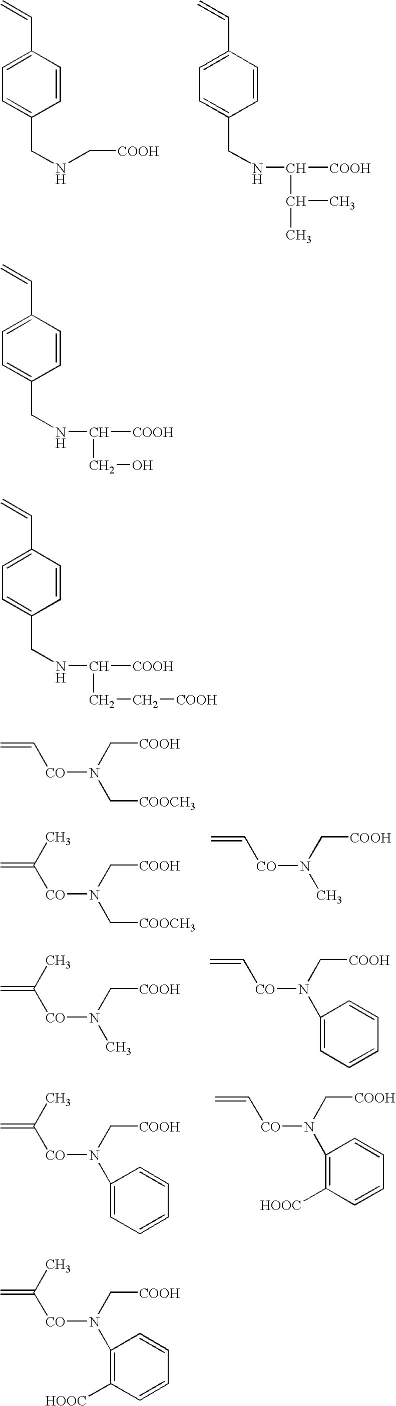

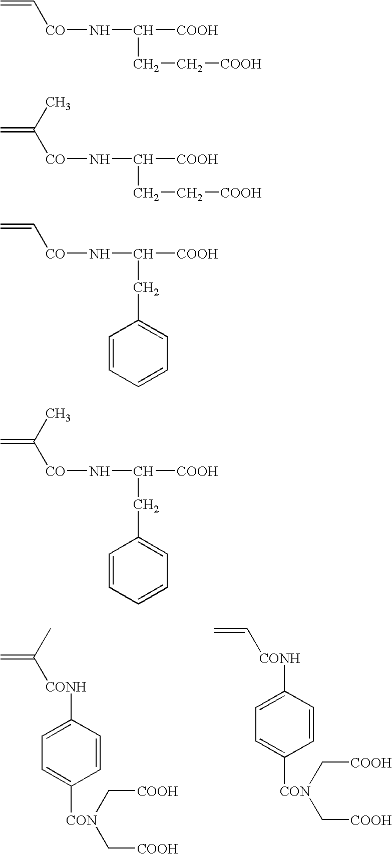

The monomer having the structure represented by Formula (1) is preferably one containing the structures below.

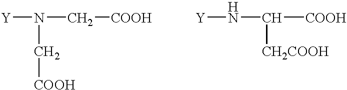

Furthermore, examples of a preferred structure of the group denoted by Y linking to the polymer main chain skeleton include the structures below.

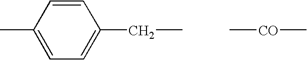

In the specific polymer, the content of the structure represented by Formula (1) is preferably 5 mol % or greater, and more preferably 20 mol % or greater, from the viewpoint of an effect in improving the plate life by interaction with an aluminum support being sufficiently exhibited.

The specific polymer that can be used in the present invention preferably has a weight-average molecular weight of 500 to 1,000,000, and more preferably 1,000 to 500,000.

The specific polymer that can be used in the present invention may, for the purpose of further enhancing the interaction with the support or enhancing an interaction with the recording layer, be a copolymer with another monomer component. Examples of said other monomer component include a ‘monomer having an onium group’ from the viewpoint of improvement of adhesion to a hydrophilized support, a ‘monomer having an acid group’ from the viewpoint of improvement of adhesion to a hydrophilized support and solubility in a developer, and a ‘monomer having a functional group that can interact with a recording layer’ from the viewpoint of improvement of adhesion to the recording layer.

Examples of the monomer having an onium group include monomers represented by Formula (A) to Formula (C) below, but are not limited thereto.

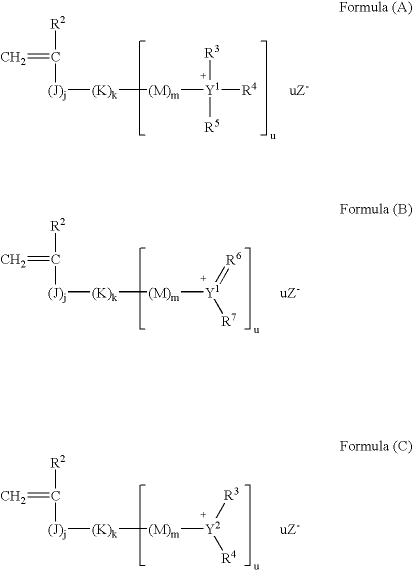

In Formulae (A) to (C), J denotes a divalent linking group. K denotes an aromatic group or a substituted aromatic group. M denotes a divalent linking group. Y¹ denotes an atom of group V in the periodic table. Y² denotes an atom of group VI in the periodic table. Z⁻ denotes a counteranion. R² denotes a hydrogen atom, an alkyl group, or a halogen atom. R³, R⁴, R⁵, and R⁷ independently denote a hydrogen atom, or an optionally substituted alkyl group, aromatic group, or aralkyl group. R⁶ denotes an alkylidine group or a substituted alkylidine group. R³ and R⁴, and R⁶ and R⁷ may be bonded to each other to form a ring. j, k, and m independently denote 0 or 1. u denotes an integer of 1 to 3.

Among the monomers having an onium group represented by Formulae (A) to (C), those below are more preferable.

J denotes —COO— or —CONH—, and K denotes a phenylene group or a substituted phenylene group. When K is a substituted phenylene group, an introduced substituent is preferably a hydroxy group, a halogen atom, or an alkyl group.

M denotes an alkylene group or a divalent linking group having a molecular formula of CₙH₂rO, CₙH₂ₙS, or CₙH₂ₙ₊₁N. Here, n denotes an integer of 1 to 12.

Y¹ denotes a nitrogen atom or a phosphorus atom, and Y² denotes a sulfur atom.

Z⁻ denotes a halogen ion, PF₆⁻, BF₄⁻, or R⁸SO₃—.

R² denotes a hydrogen atom or an alkyl group.

R³, R⁴, R⁵, and R⁷ independently denote a hydrogen atom, or an optionally substituted alkyl group having 1 to 10 carbons, aromatic group having 6 to 10 carbons, or aralkyl group having 7 to 10 carbons.

R⁶ is preferably an alkylidine group having 1 to 10 carbons or a substituted alkylidine. R³ and R⁴, and R⁶ and R⁷ may be bonded to each other to form a ring.

j, k, and m independently denote 0 or 1, and it is preferable for j and k not to be 0 at the same time.

R⁸ denotes an optionally substituted alkyl group having 1 to 10 carbons, aromatic group having 6 to 10 carbons, or aralkyl group having 7 to 10 carbons.

Among the monomers having an onium group represented by Formulae (A) to (C), those below are particularly preferable.

K denotes a phenylene group or a substituted phenylene group, and when it is a substituted phenylene group, the substituent is a hydrogen atom or an alkyl group having 1 to 3 carbons.

M denotes an alkylene group having 1 to 2 carbons, or an alkylene group having 1 to 2 carbons connected via an oxygen atom.

Z⁻ denotes a chlorine ion or R⁸SO₃⁻. R² denotes a hydrogen atom or a methyl group. j is 0, and k is 1. R⁸ denotes an alkyl group having 1 to 3 carbons.

Specific examples of the monomer having an onium group that is suitably used for the specific polymer are cited below, but the present invention is not limited thereto. Below, Me denotes a methyl group, Et denotes an ethyl group, and n-Bu denotes an n-butyl group.

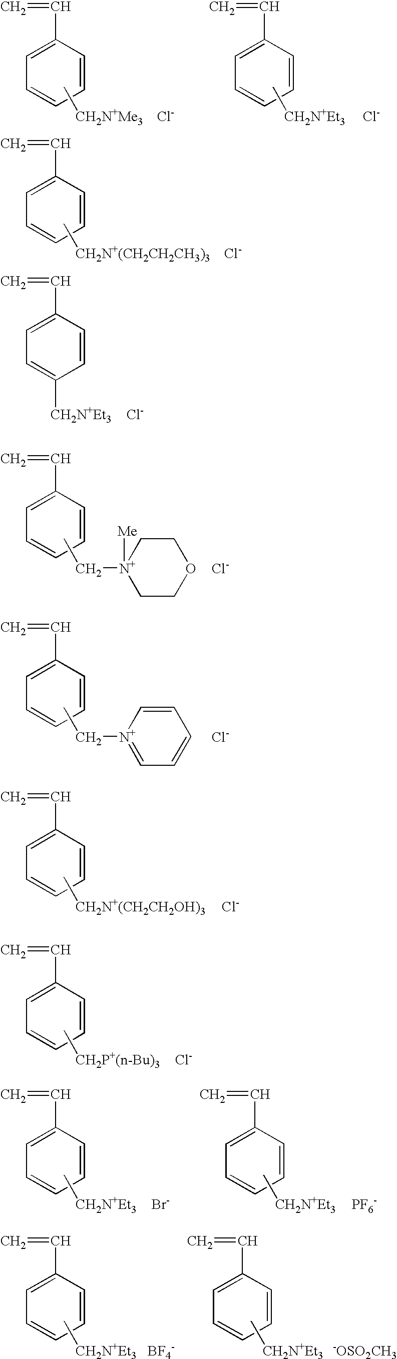

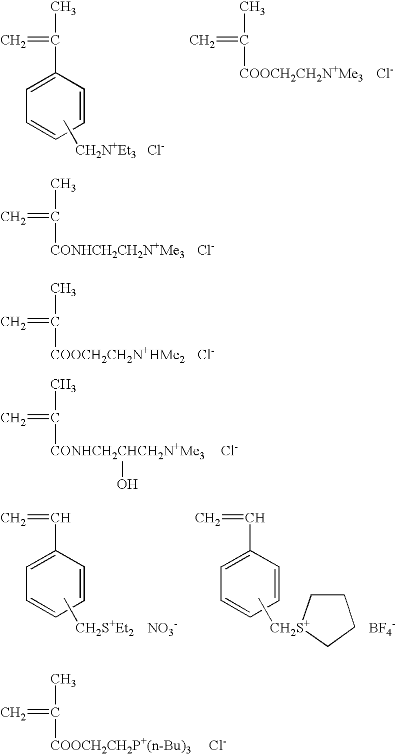

The monomer having an acid group that is suitably used for the specific polymer is explained.

The acid group contained in the monomer having an acid group is particularly preferably a carboxylic acid group, a sulfonic acid group, or a phosphonic acid group, but is not limited thereto.

### Monomer Having Carboxylic Acid Group

The monomer having a carboxylic acid group is not particularly limited as long as it is a polymerizable compound having a carboxylic acid group and a polymerizable double bond in its structure.

Preferred examples of the monomer having a carboxylic acid group include compounds represented by Formula (2) below.

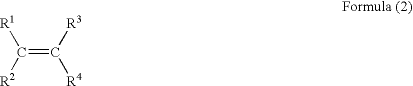

In Formula (2), R¹ to R⁴ independently denote a hydrogen atom, an alkyl group, or an organic group represented by Formula (3) below, and at least one of R¹ to R⁴ is an organic group represented by Formula (3) below.

Here, from the viewpoint of copolymerizability and the availability of starting materials when producing the specific polymer, it is preferable for 1 or 2 of R¹ to R⁴, and particularly preferably one thereof, to be an organic group represented by Formula (3) below. From the viewpoint of flexibility of the specific polymer obtained as a result of polymerization, with regard to R¹ to R⁴, other than an organic group represented by Formula (3) below, they are preferably an alkyl group or a hydrogen atom, and particularly preferably a hydrogen atom.

For the same reason, when R¹ to R⁴ are alkyl groups, they are preferably an alkyl group having 1 to 4 carbons, and particularly preferably a methyl group.

—X—COOH Formula (3)

In Formula (3), X denotes any one of a single bond, an alkylene group, an optionally substituted arylene group, and those represented by structural formulae (i) to (iii) below. From the viewpoint of polymerizability, availability, etc., it is preferably a single bond, an arylene group represented by a phenylene group, or one represented by structural formula (i) below, more preferably an arylene group or one represented by structural formula (i) below, and particularly preferably one represented by structural formula (i) below.

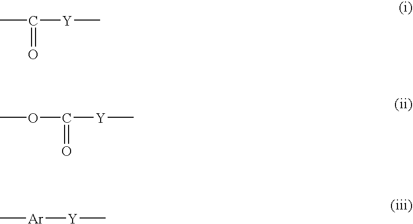

In structural formulae (i) to (iii), Y denotes a divalent linking group, and Ar denotes an optionally substituted arylene group. Y is preferably a single bond or an alkylene group having 1 to 16 carbon atoms. A methylene (—CH₂—) in the alkylene group may be substituted with an ether bond (—O—), a thio ether bond (—S—), an ester bond (—COO—), or an amide bond (—CONR—; R denotes a hydrogen atom or an alkyl group), and the bond substituting the methylene group is particularly preferably an ether bond or an ester bond.

Among such divalent linking groups, particularly preferred specific examples are listed below.

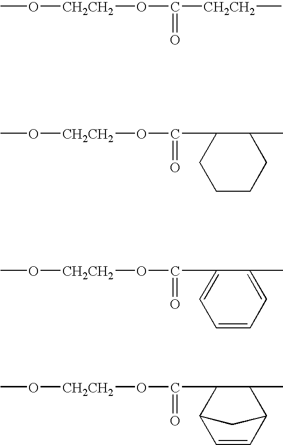

Particularly preferred examples of the carboxylic acid group-containing monomer represented by Formula (2) are listed below, but the present invention should not be construed as being limited thereto.

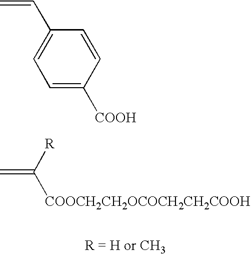

### Monomer Having a Sulfonic Acid Group

The monomer having a sulfonic acid group is not particularly limited as long as it is a polymerizable compound having a sulfonic acid group and a polymerizable double bond in its structure.

Specific examples of the monomer having a sulfonic acid group include 3-sulfopropyl acrylate, 3-sulfopropyl methacrylate, and 4-styrenesulfonic acid.

### Monomer Having a Phosphonic Acid Group

The monomer having a phosphonic acid group is not particularly limited as long as it is a polymerizable compound having a phosphonic acid group and a polymerizable double bond in its structure.

Specific preferred examples of the monomer having a phosphonic acid group include acid phosphoxyethyl methacrylate, 3-chloro-2-acid phosphoxypropyl methacrylate, and acid phosphoxypolyoxyethylene glycol monomethacrylate.

Specific examples of other monomers that can suitably be used for the specific polymer are listed, but the present invention should not be construed as being limited thereto.

(1) Acrylamides, methacrylamides, acrylic acid esters, methacrylic acid esters, and hydroxystyrenes having an aromatic hydroxy group, such as N-(4-hydroxyphenyl)acrylamide, N-(4-hydroxyphenyl)methacrylamide, o-, m-, or p-hydroxystyrene, o- or m-bromo-p-hydroxystyrene, o- or m-chloro-p-hydroxystyrene, and o-, m-, or p-hydroxyphenyl acrylate or methacrylate;
(2) unsaturated sulfonamides including acrylamides such as N-(o-aminosulfonylphenyl)acrylamide, N-(m-aminosulfonylphenyl)acrylamide, N-(p-aminosulfonylphenyl)acrylamide, N-[1-(3-aminosulfonyl)naphthyl]acrylamide, and N-(2-aminosulfonylethyl)acrylamide, methacrylamides such as N-(o-aminosulfonylphenyl)methacrylamide, N-(m-aminosulfonylphenyl)methacrylamide, N-(p-aminosulfonylphenyl)methacrylamide, N-[1-(3-aminosulfonyl)naphthyl]methacrylamide, and N-(2-aminosulfonylethyl)methacrylamide, acrylic acid esters such as o-aminosulfonylphenyl acrylate, m-aminosulfonylphenyl acrylate, p-aminosulfonylphenyl acrylate, and 1-(3-aminosulfonylphenylnaphthyl) acrylate, and methacrylic acid esters such as o-aminosulfonylphenyl methacrylate, m-aminosulfonylphenyl methacrylate, p-aminosulfonylphenyl methacrylate, and 1-(3-aminosulfonylphenylnaphthyl) methacrylate;
(3) optionally substituted phenylsulfonylacrylamides such as tosylacrylamide and optionally substituted phenylsulfonylmethacrylamides such as tosylmethacrylamide;
(4) acrylic acid esters and methacrylic acid esters having an aliphatic hydroxy group, such as 2-hydroxyethyl acrylate and 2-hydroxyethyl methacrylate;
(5) (substituted) acrylic acid esters such as methyl acrylate, ethyl acrylate, propyl acrylate, butyl acrylate, amyl acrylate, hexyl acrylate, cyclohexyl acrylate, octyl acrylate, phenyl acrylate, benzyl acrylate, 2-chloroethyl acrylate, 4-hydroxybutyl acrylate, glycidyl acrylate, and N-dimethylaminoethyl acrylate;
(6) (substituted) methacrylic acid esters such as methyl methacrylate, ethyl methacrylate, propyl methacrylate, butyl methacrylate, amyl methacrylate, hexyl methacrylate, cyclohexyl methacrylate, octyl methacrylate, phenyl methacrylate, benzyl methacrylate, 2-chloroethyl methacrylate, 4-hydroxybutyl methacrylate, glycidyl methacrylate, and N-dimethylaminoethyl methacrylate;
(7) acrylamides and methacrylamides such as acrylamide, methacrylamide, N-methylolacrylamide, N-methylolmethacrylamide, N-ethylacrylamide, N-ethylmethacrylamide, N-hexylacrylamide, N-hexylmethacrylamide, N-cyclohexylacrylamide, N-cyclohexylmethacrylamide, N-hydroxyethylacrylamide, N-hydroxyethylmethacrylamide, N-phenylacrylamide, N-phenylmethacrylamide, N-benzylacrylamide, N-benzylmethacrylamide, N-nitrophenylacrylamide, N-nitrophenylmethacrylamide, N-ethyl-N-phenylacrylamide, and N-ethyl-N-phenylmethacrylamide;
(8) vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether;
(9) vinyl esters such as vinyl acetate, vinyl chloroacetate, vinyl butyrate, and vinyl benzoate;
(10) styrenes such as styrene, (x-methylstyrene, methylstyrene, and chloromethylstyrene;
(11) vinyl ketones such as methyl vinyl ketone, ethyl vinyl ketone, propyl vinyl ketone, and phenyl vinyl ketone;
(12) olefins such as ethylene, propylene, isobutylene, butadiene, and isoprene;

### (13) N-vinylpyrrolidone, N-vinylcarbazole, 4-vinylpyridine, acrylonitrile, methacrylonitrile, etc.;

(14) lactone group-containing monomers such as pantoyllactone(meth)acrylate, α-(meth)acryloyl-γ-butyrolactone, and β-(meth)acryloyl-γ-butyrolactone; and
(15) ethylene oxide group-containing monomers such as polyethylene glycol mono(meth)acrylate, polypropylene glycol mono(meth)acrylate, and methoxypolyethylene glycol mono(meth)acrylate.

In the specific polymer, the content of said other monomer is preferably 95 mol % or less, and more preferably 80 mol % or less.

Among said other monomers, it is preferable to copolymerize (4) the acrylic acid ester and methacrylic acid ester having an aliphatic hydroxy group, (5) the acrylic acid ester, or (6) the methacrylic acid ester.

Specific examples (P-1 to P-23) of the specific polymer that can be used in the present invention are listed below, but the present invention should not be construed as being limited thereto.

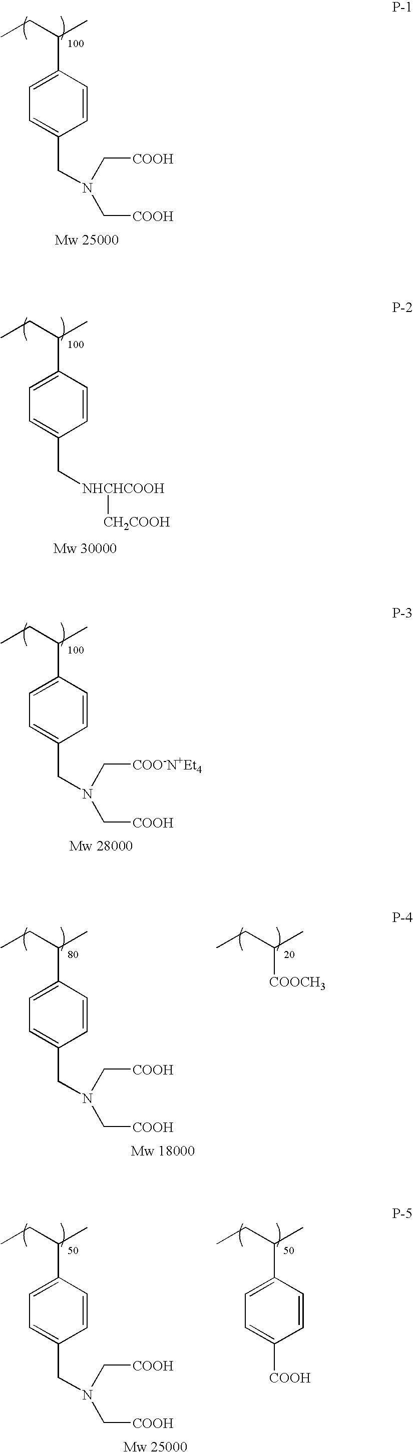

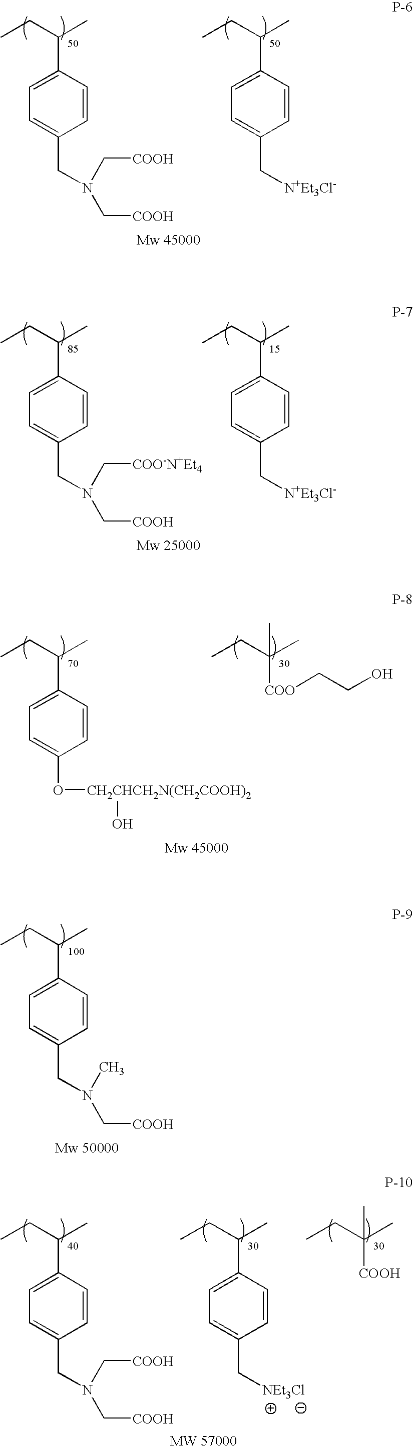

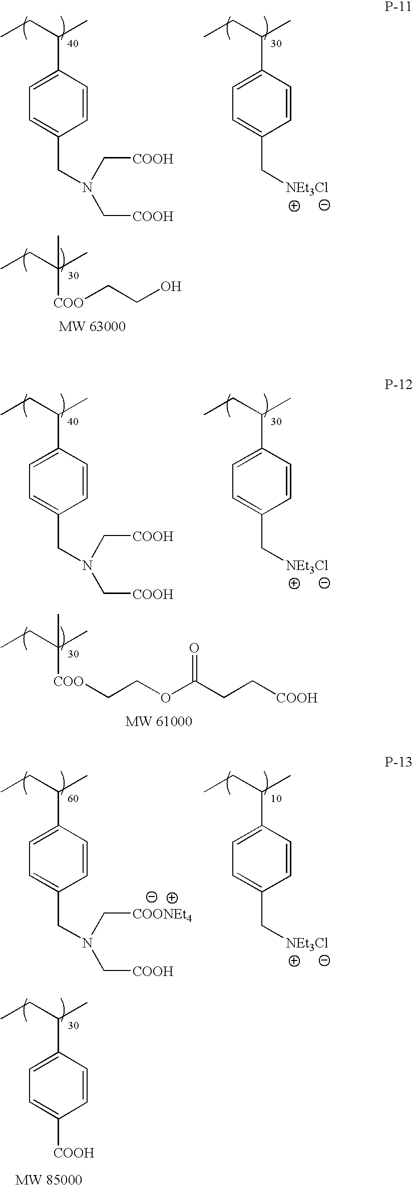

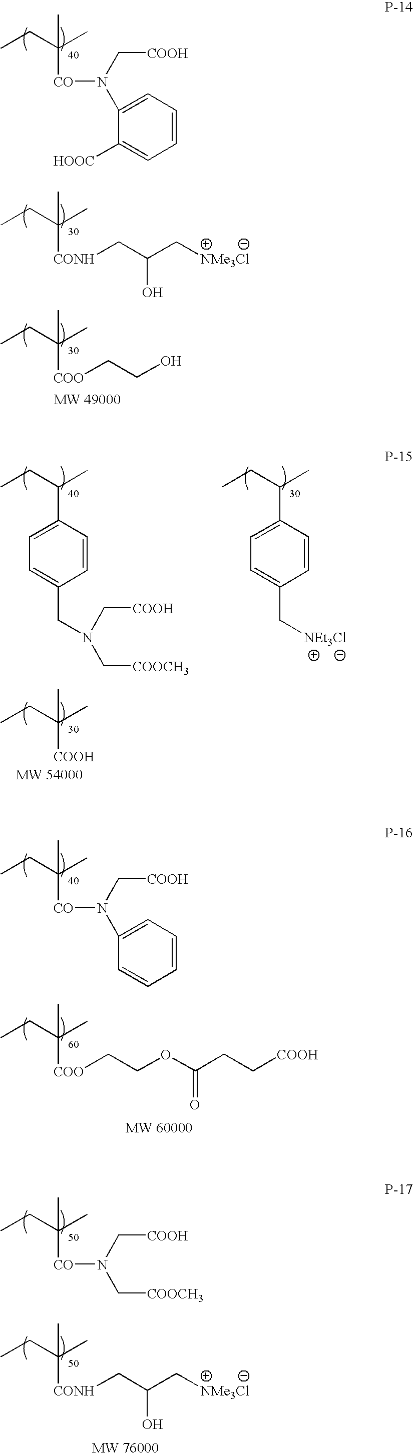

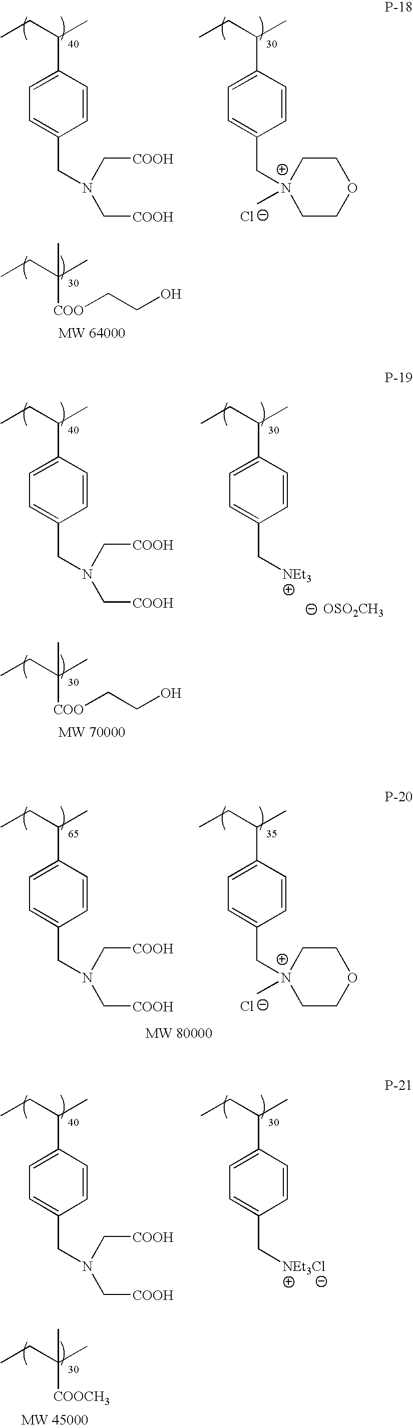

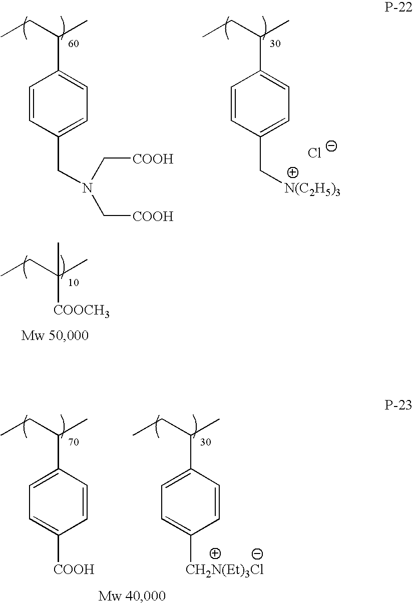

The content of the specific polymer in the undercoat layer is preferably 50 to 100 wt %, and more preferably 80 to 100 wt %, relative to the total solids content forming the undercoat layer.

### Formation of Undercoat Layer

The undercoat layer in the present invention may be provided by coating a support, which will be described later, with a coating solution in which the above-mentioned components of the undercoat layer have been dissolved (undercoat layer-forming coating solution) by various methods. The method for providing an undercoat layer is not particularly limited, but the following methods can be cited as representative examples.

That is, a method (1) in which a solution formed by dissolving the above-mentioned specific polymer in an organic solvent such as methanol, ethanol, or methyl ethyl ketone, a mixed solvent thereof, or a mixed solvent of these organic solvents and water is applied on a support and dried. A method (2) in which a support is immersed in a solution formed by dissolving the above-mentioned specific polymer in an organic solvent such as methanol, ethanol, or methyl ethyl ketone, a mixed solvent thereof, or a mixed solvent of these organic solvents and water, then washed with water or cleaned with air, etc. and dried to provide an undercoat layer.

In the above-mentioned coating method (1), a solution having a total concentration of the above-mentioned compounds of 0.005 to 10 wt % may be applied by various methods. Any coating means such as a bar coating method, a rotary coating method, a spray coating method, or a curtain coating method may be employed. In the above-mentioned method (2), the concentration of the solution is preferably 0.005 to 20 wt %, and more preferably 0.01 to 10 wt %, the immersion temperature is preferably 0° C. to 70° C., and more preferably 5° C. to 60° C., and the immersion time is preferably 0.1 sec to 5 minutes, and more preferably 0.5 to 120 sec.

With regard to the above-mentioned undercoat layer-forming coating solution, its pH is adjusted by a basic substance such as ammonia, triethylamine, or potassium hydroxide, an inorganic acid such as hydrochloric acid, phosphoric acid, sulfuric acid, or nitric acid, various acidic organic substances including an organic sulfonic acid such as nitrobenzenesulfonic acid or naphthalenesulfonic acid, an organic phosphonic acid such as phenylphosphonic acid, and an organic carboxylic acid such as benzoic acid, coumaric acid, or malic acid, or an organic chloride such as naphthalenesulfonyl chloride or benzenesulfonyl chloride, and it may be used preferably at a pH of 0 to 12, and more preferably a pH of 0 to 6.

Furthermore, in order to improve the tone reproduction properties of a lithographic printing plate, the undercoat layer-forming coating solution may contain a substance that absorbs ultraviolet rays, visible light, infrared rays, etc.

Moreover, as components of the undercoat layer, various types of organic compounds may be used. Examples thereof include carboxymethylcellulose, dextran, gum arabic, a phosphonic acid having an amino group such as 2-aminoethylphosphonic acid, an organic phosphonic acid such as an optionally substituted phenylphosphonic acid, naphthylphosphonic acid, alkylphosphonic acid, glycerophosphonic acid, methylenediphosphonic acid, or ethylenediphosphonic acid, an organic phosphoric acid such as an optionally substituted phenylphosphoric acid, naphthylphosphoric acid, alkylphosphoric acid, or glycerophosphoric acid, an organic phosphinic acid such as an optionally substituted phenylphosphinic acid, naphthylphosphinic acid, alkylphosphinic acid, or glycerophosphinic acid, an amino acid such as glycine or β-alanine, and an amine hydrochloride having a hydroxy group such as triethanolamine hydrochloride, and two or more types thereof may be used as a mixture.

It is also preferable for the undercoat layer to comprise a compound having an onium group. Compounds having an onium group are described in detail in JP-A-2000-10292, JP-A-2000-108538, JP-A-2000-241962, etc.

Preferred examples thereof include at least one compound selected from the group consisting of polymer compounds having a structural unit represented by poly(p-vinylbenzoic acid), etc. in the molecule. Specific examples thereof include a copolymer of p-vinylbenzoic acid and vinylbenzyltriethylammonium chloride and a copolymer of p-vinylbenzoic acid and a vinylbenzyltrimethylammonium salt.

This organic undercoat layer may be provided by the following methods. That is, there is a method in which a solution formed by dissolving the above-mentioned organic compounds in water, an organic solvent such as methanol, ethanol, or methyl ethyl ketone, or a mixed solvent thereof is applied onto an aluminum sheet and dried or a method in which an aluminum sheet is immersed in a solution formed by dissolving the above-mentioned organic compounds in water, an organic solvent such as methanol, ethanol, or methyl ethyl ketone, or a mixed solvent thereof so as to make the above-mentioned compounds adsorb thereon, followed by washing with water, etc. and drying to provide an organic undercoat layer. In the former method, a solution of the above-mentioned organic compounds at a concentration of preferably 0.005 to 10 wt % may be applied by various methods. In the latter method, the concentration of the solution is preferably 0.01 to 20 wt %, and more preferably 0.05 to 5 wt %, the immersion temperature is preferably 20° C. to 90° C., and more preferably 25° C. to 50° C., and the immersion time is preferably 0.1 sec. to 20 min., and more preferably 2 sec. to 1 min. With regard to the solution used therefor, its pH may be adjusted by a basic substance such as ammonia, triethylamine, or potassium hydroxide, or an acidic substance such as hydrochloric acid or phosphoric acid so that the pH is in the range of 1 to 12. A yellow dye may be added for the purpose of improving the tone reproduction properties of the photosensitive layer.

The amount of organic undercoat layer applied is preferably 2 to 200 mg/m², and more preferably 5 to 100 mg/m². When the amount applied is in the above-mentioned range, a sufficient plate life can be obtained.

The infrared-sensitive lithographic printing plate produced above is imagewise exposed and then developed.

### Plate-Making

With regard to the infrared-sensitive lithographic printing plate of the present invention, an image is formed by irradiation with infrared rays. Specifically, direct imagewise recording by means of a thermal recording head, etc., scanning exposure by means of an infrared laser, or high illumination intensity flash exposure by means of a xenon discharge lamp, infrared lamp exposure, etc. is employed, and it is desirable that exposure is carried out by means of a high power solid-state infrared laser such as a semiconductor laser or a YAG laser that emits infrared having a wavelength of 700 to 1,200 nm.

The exposed infrared-sensitive lithographic printing plate of the present invention is subjected to a development treatment and a post-treatment by means of a finisher or a protection gum to give a printing plate. These treatments may employ known processing equipment such as automatic development equipment.

A treatment agent used in the development treatment and the post-treatment for the infrared-sensitive lithographic printing plate of the present invention may be selected as appropriate from known treatment agents.

A suitable developer is a developer having a pH of 9.0 to 14.0, and preferably 12.0 to 13.5. A conventionally known aqueous alkaline solution may be used as the developer. Among the above-mentioned aqueous alkaline solutions, particularly suitable examples thereof include a conventionally well-known, so-called ‘silicate developer’, which is an aqueous solution having a pH of 12 or greater and which comprises as a base an alkali silicate or an alkali silicate formed by mixing a base with a silicon compound, and a so-called ‘nonsilicate developer’ described in JP-A-8-305039, JP-A-11-109637, etc. comprising no alkali silicate and comprising a non-reducing sugar (an organic compound having buffer action) and a base.

Furthermore, it is preferable for the developer to comprise an anionic surfactant and/or an amphoteric surfactant from the viewpoint of development acceleration and prevention of the occurrence of deposits.

When the lithographic printing plate of the present invention is subjected to burning, it is preferable to carry it out by a conventionally known method in which a burning counter-etching solution is used and a burning processor, etc. is used.

The lithographic printing plate obtained by such treatments is set in an offset printing machine, etc. for producing a large number of prints.

In accordance with the present invention, there can be provided a photosensitive lithographic printing plate having excellent scratch resistance in a slip sheet-less configuration and also having excellent scratch resistance in a production process, a transport process, and a plate-making process.

### EXAMPLES

The present invention is explained in detail below by reference to Examples, but the present invention is not limited thereby.

### Preparation of Support

### Aluminum Sheet

A melt was prepared using an aluminum alloy containing Si (0.06 wt %), Fe (0.30 wt %), Cu (0.026 wt %), Mn (0.001 wt %), Mg (0.001 wt %), Zn (0.001 wt %), and Ti (0.02 wt %), the remainder being Al and its inevitable impurities, and it was subjected to a melt treatment and filtration, and then formed into an ingot having a thickness of 500 mm and a width of 1,200 mm by a DC casting method. After the surface thereof was shaved off by an average thickness of 10 mm by means of a scalping machine, it was thermally maintained at 550° C. for about 5 hours, and when the temperature dropped to 400° C., it was made into a rolled sheet having a thickness of 2.7 mm by means of a hot rolling mill. It was further thermally treated at 500° C. by means of a continuous annealing machine, and then finished so as to have a thickness of 0.24 mm by means of cold rolling, thus giving an aluminum sheet of JIS 1050 material. After making the width of this aluminum sheet 1,030 mm, it was subjected to the surface treatments below.

(a) Alkali Etching Treatment

The aluminum sheet obtained above was subjected to an etching treatment by means of a spray using an aqueous solution of sodium hydroxide (concentration 26 wt %, aluminum ion concentration 6.5 wt %) at a temperature of 70° C. so as to dissolve 6 g/m² of the aluminum sheet. Subsequently, it was washed with well water by means of a spray.

(b) Desmutting Treatment

A desmutting treatment was carried out by means of a spray using an aqueous solution having a nitric acid concentration of 1 wt % and a temperature of 30° C. (containing 0.5 wt % of aluminum ion), and following this washing with water was carried out by means of a spray. The aqueous solution of nitric acid used in desmutting employed liquid waste from a step involving carrying out electrochemical roughening using alternating current in an aqueous solution of nitric acid.

(c) Electrochemical Roughening Treatment

An electrochemical roughening treatment was carried out consecutively using an ac voltage of 60 Hz. An electrolytic solution in this process was a 10.5 g/L aqueous solution of nitric acid (containing 5 g/L of aluminum ion and 0.007 wt % of ammonium ion), and the temperature was 50° C. The electrochemical roughening treatment was carried out using as an ac power source waveform a trapezoidal rectangular wave alternating current having a duty ratio of 1:1 and a time TP from zero to peak current value of 0.8 msec, with a carbon electrode as a counter electrode. Ferrite was used as an auxiliary anode. The electrolysis vessel used was of a radial cell type.

The current density was 30 A/dm² as a peak current value, and the quantity of electricity was 220 C/dm² as the total quantity of electricity when the aluminum sheet was the anode. 5% of the current flowing from the power source was diverted to the auxiliary anode.

Following this, washing with well water was carried out by means of a spray.

(d) Alkali Etching Treatment

The aluminum sheet was subjected to an etching treatment at 32° C. by means of a spray using a sodium hydroxide concentration of 26 wt % and an aluminum ion concentration of 6.5 wt % so as to dissolve 0.50 g/m² of the aluminum sheet, remove a smut component containing aluminum hydroxide as a main component formed in the previous paragraph when carrying out electrochemical roughening using alternating current, and dissolve an edge portion of a pit formed to thus make the edge portion smooth. Subsequently, washing with well water was carried out by means of a spray.

(e) Desmutting Treatment

A desmutting treatment was carried out by means of a spray using an aqueous solution having a nitric acid concentration of 15 wt % and a temperature of 30° C. (containing 4.5 wt % of aluminum ion), and following this washing with well water was carried out by means of a spray. The aqueous solution of nitric acid used in the above-mentioned desmutting employed liquid waste from the step involving carrying out electrochemical roughening using alternating current in an aqueous solution of nitric acid.

(f) Electrochemical Roughening Treatment

An electrochemical roughening treatment was carried out consecutively using an ac voltage of 60 Hz. The electrolytic solution in this process was a 5.0 g/L aqueous solution of hydrochloric acid (containing 5 g/L of aluminum ion), and the temperature was 35° C. The electrochemical roughening treatment was carried out using as an ac power source waveform a rectangular wave alternating current having a duty ratio of 1:1 and a time TP from zero to peak current value of 0.8 msec, with a carbon electrode as a counter electrode. Ferrite was used as an auxiliary anode. The electrolysis vessel used was of a radial cell type.

The current density was 25 A/dm² as a peak current value, and the quantity of electricity was 50 C/dm² as the total quantity of electricity when the aluminum sheet was the anode.

Following this, washing with well water was carried out by means of a spray.

(g) Alkali Etching Treatment

The aluminum sheet was subjected to an etching treatment at 32° C. by means of a spray using a sodium hydroxide concentration of 26 wt % and an aluminum ion concentration of 6.5 wt % so as to dissolve 0.10 g/m² of the aluminum sheet, remove a smut component containing aluminum hydroxide as a main component formed in the previous paragraph when carrying out the electrochemical roughening treatment using alternating current, and dissolve an edge portion of a pit formed to thus make the edge portion smooth. Subsequently, washing with well water was carried out by means of a spray.

(h) Desmutting Treatment

A desmutting treatment was carried out by means of a spray using an aqueous solution having a sulfuric acid concentration of 25 wt % and a temperature of 60° C. (containing 0.5 wt % of aluminum ion), and following this washing with well water was carried out by means of a spray.

(i) Anodizing Treatment

Sulfuric acid was used as an electrolytic solution. The electrolytic solution had a sulfuric acid concentration of 170 g/L (containing 0.5 wt % of aluminum ion) and a temperature of 38° C. Following this, washing with well water was carried out by means of a spray.

The current density was about 30 A/dm² in both cases. The final amount of oxidized film was 2.7 g/m².

(i) Alkali Metal Silicate Treatment

The aluminum support obtained by the anodizing treatment was immersed in a treatment vessel with a 1 wt % aqueous solution of sodium silicate No. 3 at a temperature of 30° C. for 10 sec. so as to carry out an alkali metal silicate treatment (silicate treatment). After this, washing with well water was carried out by means of a spray. In this case, the amount of silicate deposited was 3.5 mg/m².

### Support A

Support A was prepared by carrying out the steps (a) to (j) above in sequence.

### Support B

Support B was prepared by carrying out the steps for preparing Support A in sequence except that steps (c), (d), and (e) were not carried out, so that the total quantity of electricity in step (f) became 450 C/dm².

### Examples 1 to 3 and Comparative Examples 1 to 3

The surface-treated reverse side of the support A obtained above was provided with Backcoat layers 1 to 3 of Examples 1 to 3, Backcoat layer 4 of Comparative Example 1, and Backcoat layer 5 of Comparative Example 2. In Comparative Example 3, a backcoat was not provided.

### Backcoat Layer 1

### Example 1

The backcoat solution below was applied by means of a bar coater and dried at 100° C. for 4 minutes to give a backcoat with a dry coat weight of 3 g/m². Subsequently, it was exposed using a UNILEC URM-600R printing light source manufactured by Ushio U-Tech Inc. at a distance of 1 m from the light source at 800 counts.

| | |
|---|---|
| UV-2010B (violet light series urethane oligomer, | 2.25 parts by weight |
| manufactured by the Nippon Synthetic | |
| Chemical Industry Co., Ltd.) | |
| Irgacure 184 (manufactured by CIBA GEIGY) | 0.15 parts by weight |
| A-TMMT (pentaerythritol tetraacrylate, | 1.65 parts by weight |
| manufactured by Shin-Nakamura Chemical Co., | |
| Ltd.) | |
| Methyl ethyl ketone (MEK) | 10.0 parts by weight |

### Backcoat Layer 2

### Example 2

The backcoat solution below was applied by means of a bar coater and dried at 100° C. for 4 minutes to give a backcoat with a dry coat weight of 3 g/m². Subsequently, it was exposed using a UNILEC URM-600R printing light source manufactured by Ushio U-Tech Inc. at a distance of 1 m from the light source at 800 counts.

| | |
|---|---|
| UV-3000B (violet light series urethane oligomer, | 2.25 parts by weight |
| manufactured by the Nippon | |
| Synthetic Chemical Industry Co., Ltd.) | |
| Irgacure 184 (manufactured by CIBA GEIGY) | 0.15 parts by weight |
| A-TMMT (pentaerythritol tetraacrylate, | 1.65 parts by weight |
| manufactured by Shin-Nakamura Chemical Co., | |
| Ltd.) | |
| MEK | 10.0 parts by weight |

### Backcoat Layer 3

### Example 3

A 20 μm thick ethylene/propylene rubber (EPDM) sheet was bonded by an adhesive to provide a backcoat.

### Backcoat Layer 4

### Comparative Example 1

The sol-gel liquid below was applied by means of a bar coater and dried at 100° C. for 30 sec. to give a backcoat layer with a dry coat weight of 120 mg/m².

Sol-gel reaction liquid

| | |
|---|---|
| Tetraethyl silicate | 50 parts by weight |
| Water | 90 parts by weight |
| Methanol | 10 parts by weight |
| Phosphoric acid | 0.1 parts by weight |

When the above-mentioned components were mixed and stirred, heat was generated in about 30 minutes. After a reaction was carried out by stirring for 60 minutes, the liquid below was added to give a backcoat solution.

| | |
|---|---|
| Pyrogallol-formaldehyde condensation- | 5 parts by weight |
| polymerization resin (Mw: 2,200, organic | |
| polymer compound) | |
| Dibutyl maleate | 5 parts by weight |
| Methanol silica sol (colloidal silica sol, | 50 parts by weight |
| manufactured by Nissan Chemical Industries, | |
| Ltd., methanol 30%) | |
| Megafac F780 (F-based surfactant, manufactured by | 0.5 parts by weight |
| Dainippon Ink and Chemicals, Inc., methyl ethyl | |
| ketone 30%) | |
| Methanol | 800 parts by weight |
| 1-Methoxy-2-propanol | 270 parts by weight |

### Backcoat Layer 5

### Comparative Example 2

The backcoat solution below was applied by means of a bar coater and dried at 100° C. for 60 sec to give a backcoat with a dry coat weight of 200 mg/m².

| | | |
|---|---|---|
| Saturated copolymer polyester resin (Kemit | 3 | parts by weight |
| K-1294, manufactured by Toray Industries Inc.) | | |
| Megafac F780 (F-based surfactant, manufactured | 0.2 | parts by weight |
| by Dainippon Ink and Chemicals, Inc., methyl | | |
| ethyl ketone 30%) | | |
| Methyl ethyl ketone | 100 | parts by weight |

### Formation of Organic Undercoat Layer

The surface-treated side of the support of Example 1 to Example 3 and Comparative Example 1 to Comparative Example 3 with the backcoat layer provided as above was coated with the organic undercoat solution below by means of a bar coater and dried at 80° C. for 15 sec. to give an organic undercoat layer at a dry coat weight of 18 mg/m².

| | | |
|---|---|---|
| Polymer compound below | 0.3 | parts by weight |
| Methanol | 100 | parts by weight |

| | | |
|---|---|---|
| 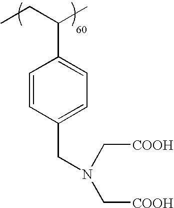 | 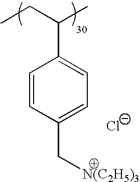 | 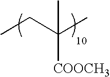 |

Polymer compound

### Formation of Recording Layer

The surface of the organic undercoat layer provided as above was coated with the recording layer-forming coating solution 1 below by means of a bar coater and dried in a PH200 PERFECT OVEN manufactured by Tabai Espec Co. at 130° C. for 50 sec. to give a recording layer at a dry coat weight of 1.3 g/m². Following this, it was coated with the recording layer-forming coating solution 2 below by means of a bar coater and dried in a PH200 PERFECT OVEN manufactured by Tabai Espec Co. at 130° C. for 60 sec. to give a recording layer at a dry coat weight of 0.26 g/m², thus giving infrared-sensitive lithographic printing plates of Example 1 to Example 3, and Comparative Example 1 to Comparative Example 3.

Recording layer-forming coating solution 1

| | | |
|---|---|---|
| N-(4-Aminosulfonylphenyl)methacrylamide/acrylonitrile/methyl methylacrylate | 1.9 | parts by weight |
| copolymer (36/34/30 wt %: weight-average molecular weight 50,000, acid value | | |
| 2.65) | | |
| m-/p-Cresol novolac | 0.3 | parts by weight |

(m/p = 6/4, weight-average molecular weight 4,500, containing unreacted cresol
at 0.8 wt %)

| | | |
|---|---|---|
| Cyanine dye A (structure below) | 0.13 | parts by weight |
| 4,4′-Bishydroxyphenylsulfone | 0.13 | parts by weight |
| Tetrahydrophthalic anhydride | 0.19 | parts by weight |
| p-Toluenesulfonic acid | 0.008 | parts by weight |
| 3-Methoxy-4-diazodiphenylamine hexafluorophosphate | 0.032 | parts by weight |
| Ethyl violet with counterion changed to 6-hydroxy-2-naphthalenesulfonate ion | 0.078 | parts by weight |
| Megafac F780 (F-based surfactant, manufactured by Dainippon Ink and | 0.2 | parts by weight |
| Chemicals, Inc., methyl ethyl ketone 30%) | | |
| Methyl ethyl ketone | 16.0 | parts by weight |
| 1-Methoxy-2-propanol | 8.0 | parts by weight |
| γ-Butyrolactone | 8.0 | parts by weight |

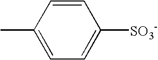

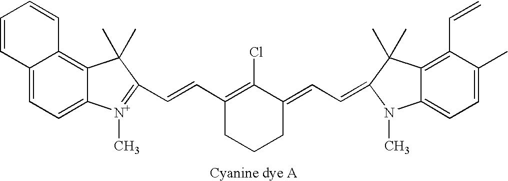

Recording layer-forming coating solution 2

| | | |
|---|---|---|
| Phenol/m-/p-cresol novolac (phenol/m/p = 5/3/2, weight average molecular | 0.27 | parts by weight |
| weight 5,000, containing untreated cresol at 0.8 wt %) | | |
| Acrylic resin B (structure below) | 0.042 | parts by weight |
| The cyanine dye A above | 0.019 | parts by weight |
| Long chain alkyl group-containing polymer C (structure below) | 0.042 | parts by weight |
| Sulfonium salt compound D (structure below) | 0.065 | parts by weight |
| Compound Y | 0.004 | parts by weight |
| Megafac F780 (F-based surfactant, manufactured by Dainippon Ink and | 0.02 | parts by weight |
| Chemicals, Inc., methyl ethyl ketone 30%) | | |
| F-based surfactant E (methyl ethyl ketone 60%) | 0.032 | parts by weight |
| Methyl ethyl ketone | 13.0 | parts by weight |
| 1-Methoxy-2-propanol | 7.0 | parts by weight |

| | | |
|---|---|---|
| 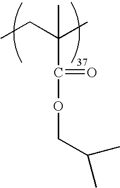 | 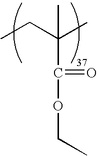 | 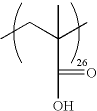 |

Acrylic resin B

| | |
|---|---|
| 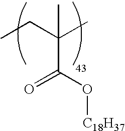 | 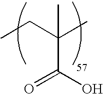 |

Long chain alkyl group-containing polymer C

| | |
|---|---|
| 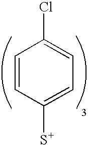 | 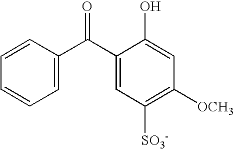 |

Sulfonium salt compound D

| | |
|---|---|
| 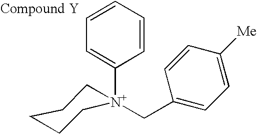 | 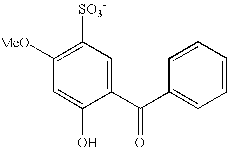 |

| | |
|---|---|
| 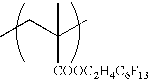 | 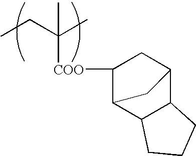 |

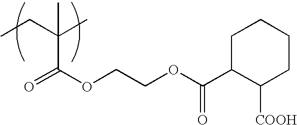

F-based surfactant E

### Examples 4 to 6

Infrared-sensitive lithographic printing plates of Examples 4 to 6 were obtained in the same manner as in Examples 1 to 3 except that the support B prepared above was used as a support when providing the same backcoat layer, organic undercoat layer, image-forming layer 1, and image-forming layer 2.

### Comparative Examples 4 to 6

Infrared-sensitive lithographic printing plates of Comparative Examples 4 to 6 were obtained in the same manner as in Comparative Examples 1 to 3 except that the support B prepared above was used as a support when providing the same backcoat layer, organic undercoat layer, image-forming layer 1, and image-forming layer 2.

### Evaluation

With regard to the infrared-sensitive lithographic printing plates of the Examples and Comparative Examples thus obtained, ‘1. Hardness of backcoat layer’ was measured, and ‘2. Occurrence of scratching during transport’ and ‘3. Occurrence of scratching in autoloader’ were evaluated.

### 1. Hardness of Backcoat Layer

Each of the infrared-sensitive lithographic printing plates obtained was subjected to a measurement of hardness for the backcoat layer under the measurement conditions below. The results are given in Table 1.

### Triboscope Measurement Conditions

Measurement equipment: Multimode AFM (manufactured by Veeco)+Triboscope (manufactured by Hysitron)

### Indentor: Berkovich type (S/N: TI-064)

Set load: 100 μN
Application speed: 20 μN/s
Maximum load duration: 2 s

### AFM Measurement Conditions

Measurement equipment: AFM (D3100/Nanoscope IIIa type, manufactured by Veeco)

### Cantilever: AC160TS manufactured by Olympus Imaging Corp.

### 2. Evaluation of the Occurrence of Scratching During Transport

Each of the infrared-sensitive lithographic printing plates obtained was cut into 30 sheets of 1,030 mm×800 mm. These 30 sheets were stacked without inserting slip sheets, a 0.5 mm sheet of cardboard was placed on the top and the bottom, the four corners were held by tape, and the stack was packaged using aluminum kraft paper. This was further packaged in a cardboard outer case and sealed with tape to give a slip sheet-less package configuration. This was placed on a pallet and transported by truck for a distance of 2,000 km, and then opened. The opened infrared-sensitive lithographic printing plate was set in a LP-940HII automatic developing machine manufactured by Fuji Photo Film Co., DT-2 developer manufactured by Fuji Photo Film Co., Ltd. was charged at 1:8, and development was carried out at a development temperature of 32° C. for a development time of 12 sec. The electrical conductivity of the developer at this time was 43 mS/cm. The developed lithographic printing plate was examined visually for the presence or absence of image area dropouts caused by transport, and evaluated.

When there were no dropouts in the image area, it was evaluated as ‘Good’, and when there were dropouts in the image area, it was evaluated as ‘Poor’. The results are given in Table 1.

### 3. Evaluation of the Occurrence of Scratching in Autoloader

10 lithographic printing plates having the same size as above were set in a cassette of a Luxel T-9800CTP single autoloader manufactured by Fuji Photo Film Co., Ltd. without inserting slip sheets, loaded on a drum by automatically feeding them, then fed out without carrying out exposure, and developed in an LP-940HII automatic developing machine manufactured by Fuji Photo Film Co., Ltd. charged with DT-2 developer (diluted at 1:8) manufactured by Fuji Photo Film Co., Ltd. and FG-1 finisher (diluted at 1:1) manufactured by Fuji Photo Film Co., Ltd. at a development temperature of 32° C. for a development time of 12 sec. The electrical conductivity of the developer at this time was 43 mS/cm. The developed lithographic printing plates were visually examined for the occurrence of scratching due to loading and unloading and evaluated.

When there was no scratching, it was evaluated as ‘Good’, and when there was scratching, it was evaluated as ‘Poor’. The results are given in Table 1.

TABLE 1

| | | | Vickers | Occurrence of | |
|---|---|---|---|---|---|
| | | | hardness | scratching | Occurrence |
| | | | of backcoat | during | of scratching |
| | Support | Backcoat layer | layer | transport | in autoloader |
| Ex. 1 | A | Coated with | 0.02 | Good | Good |
| | | urethane oligomer | | | |
| | | and then | | | |
| | | photocured | | | |
| Ex. 2 | A | Coated with | 0.02 | Good | Good |
| | | urethane oligomer | | | |
| | | and then | | | |
| | | photocured | | | |
| Ex. 3 | A | Ethylene- | 0.03 | Good | Good |
| | | butadiene rubber | | | |
| Ex. 4 | B | Coated with | 0.02 | Good | Good |
| | | urethane oligomer | | | |
| | | and then | | | |
| | | photocured | | | |
| Ex. 5 | B | Coated with | 0.02 | Good | Good |
| | | urethane oligomer | | | |
| | | and then | | | |
| | | photocured | | | |
| Ex. 6 | B | Ethylene- | 0.03 | Good | Good |
| | | butadiene rubber | | | |
| Comp. Ex. 1 | A | Sol-gel | 0.8 | Poor | Poor |
| Comp. Ex. 2 | A | Saturated | 0.3 | Poor | Poor |
| | | polyester resin | | | |
| Comp. Ex. 3 | A | None | 1.2 | Poor | Poor |
| Comp. Ex. 4 | B | Sol-gel | 0.8 | Poor | Poor |
| Comp. Ex. 5 | B | Saturated | 0.3 | Poor | Poor |
| | | polyester resin | | | |
| Comp. Ex. 6 | B | None | 1.2 | Poor | Poor |

As is clear from Table 1, the infrared-sensitive lithographic printing plate of the present invention was resistant to scratching during transport and scratching in an autoloader, and good results were exhibited.

Furthermore, good results could be obtained by changing the surface treatment conditions for the support.

### Examples 7 to 9 and Comparative Examples 7 to 9

### Preparation of Support

### Aluminum Sheet

A melt was prepared using an aluminum alloy containing Si (0.06 wt %), Fe (0.30 wt %), Cu (0.026 wt %), Mn (0.001 wt %), Mg (0.001 wt %), Zn (0.001 wt %), and Ti (0.02 wt %), the remainder being Al and its inevitable impurities, and it was subjected to a melt treatment and filtration, and then formed into an ingot having a thickness of 500 mm and a width of 1,200 mm by a DC casting method. After the surface thereof was shaved off by an average thickness of 10 mm by means of a scalping machine, it was thermally maintained at 550° C. for about 5 hours, and when the temperature dropped to 400° C., it was made into a rolled sheet having a thickness of 2.7 mm by means of a hot rolling mill. It was further thermally treated at 500° C. by means of a continuous annealing machine, and then finished so as to have a thickness of 0.24 mm by means of cold rolling, thus giving an aluminum sheet of JIS 1050 material. After making the width of this aluminum sheet 1,030 mm, it was subjected to the surface treatments below.

(a) Mechanical Roughening Treatment

The surface of the aluminum sheet was subjected to a mechanical roughening treatment by means of a rotating roll-shaped nylon brush while supplying a suspension of an abrasive (pumice) having a specific gravity of 1.12 in water as an abrasive slurry to the surface of the aluminum sheet. The abrasive had an average particle size of 8 μm and a maximum particle size of 50 μm. The material of the nylon brush was nylon-6,10, the bristle length was 50 mm, and the diameter of the bristles was 0.3 mm. The nylon brush was formed by making holes in a stainless steel tube having a diameter of 300 mm and densely implanting the bristles. Three rotating brushes were used. The distance of two support rolls (φ200 mm) below the brush was 300 mm. The brush rolls were pressed against the aluminum sheet so that the load on a drive motor for rotating the brushes increased by 7 kW from the load before pressing the brush rolls. The direction of rotation of the brushes was the same as the direction in which the aluminum sheet moved. The rotational speed of the brushes was 200 rpm.

(b) Alkali Etching Treatment

The aluminum sheet obtained above was subjected to an etching treatment by means of a spray using an aqueous solution of sodium hydroxide (concentration 26 wt %, aluminum ion concentration 6.5 wt %) at a temperature of 70° C. so as to dissolve 8 g/m² of the aluminum sheet. Subsequently, it was washed with well water by means of a spray.

(c) Desmutting Treatment

A desmutting treatment was carried out by means of a spray using an aqueous solution having a nitric acid concentration of 1 wt % and a temperature of 30° C. (containing 0.5 wt % of aluminum ion), and following this washing with water was carried out by means of a spray. The aqueous solution of nitric acid used in desmutting employed liquid waste from a step involving carrying out electrochemical roughening using alternating current in an aqueous solution of nitric acid.

(d) Electrochemical Roughening Treatment

An electrochemical roughening treatment was carried out consecutively using an ac voltage of 60 Hz. An electrolytic solution in this process was a 10.5 g/L aqueous solution of nitric acid (containing 5 g/L of aluminum ion and 0.007 wt % of ammonium ion), and the temperature was 50° C. The electrochemical roughening treatment was carried out using as an ac power source waveform a trapezoidal rectangular wave alternating current having a duty ratio of 1:1 and a time TP from zero to peak current value of 0.8 msec, with a carbon electrode as a counter electrode. Ferrite was used as an auxiliary anode. The electrolysis vessel used was of a radial cell type.

The current density was 30 A/dm² as a peak current value, and the quantity of electricity was 220 C/dm² as the total quantity of electricity when the aluminum sheet was the anode. 5% of the current flowing from the power source was diverted to the auxiliary anode.

Following this, washing with well water was carried out by means of a spray.

(e) Alkali Etching Treatment

The aluminum sheet was subjected to an etching treatment at 32° C. by means of a spray using a sodium hydroxide concentration of 26 wt % and an aluminum ion concentration of 6.5 wt % so as to dissolve 0.50 g/m² of the aluminum sheet, remove a smut component containing aluminum hydroxide as a main component formed in the previous paragraph when carrying out electrochemical roughening using alternating current, and dissolve an edge portion of a pit formed to thus make the edge portion smooth. Subsequently, washing with well water was carried out by means of a spray.

(f) Desmutting Treatment

A desmutting treatment was carried out by means of a spray using an aqueous solution having a nitric acid concentration of 15 wt % and a temperature of 30° C. (containing 4.5 wt % of aluminum ion), and following this washing with well water was carried out by means of a spray. The aqueous solution of nitric acid used in the above-mentioned desmutting employed liquid waste from the step involving carrying out electrochemical roughening using alternating current in an aqueous solution of nitric acid.

(g) Electrochemical Roughening Treatment

An electrochemical roughening treatment was carried out consecutively using an ac voltage of 60 Hz. The electrolytic solution in this process was a 7.5 g/L aqueous solution of hydrochloric acid (containing 5 g/L of aluminum ion), and the temperature was 35° C. The electrochemical roughening treatment was carried out using as an ac power source waveform a rectangular wave alternating current having a duty ratio of 1:1 and a time TP from zero to peak current value of 0.8 msec, with a carbon electrode as a counter electrode. Ferrite was used as an auxiliary anode. The electrolysis vessel used was of a radial cell type.

The current density was 25 A/dm² as a peak current value, and the quantity of electricity was 50 C/dm² as the total quantity of electricity when the aluminum sheet was the anode.

Following this, washing with well water was carried out by means of a spray.

(h) Alkali Etching Treatment

The aluminum sheet was subjected to an etching treatment at 32° C. by means of a spray using a sodium hydroxide concentration of 26 wt % and an aluminum ion concentration of 6.5 wt % so as to dissolve 0.10 g/m² of the aluminum sheet, remove a smut component containing aluminum hydroxide as a main component formed in the previous paragraph when carrying out the electrochemical roughening treatment using alternating current, and dissolve an edge portion of a pit formed to thus make the edge portion smooth. Subsequently, washing with well water was carried out by means of a spray.

(i) Desmutting Treatment

A desmutting treatment was carried out by means of a spray using an aqueous solution having a sulfuric acid concentration of 25 wt % and a temperature of 60° C. (containing 0.5 wt % of aluminum ion), and following this washing with well water was carried out by means of a spray.

(i) Anodizing Treatment

Sulfuric acid was used as an electrolytic solution. The electrolytic solution had a sulfuric acid concentration of 170 g/L (containing 0.5 wt % of aluminum ion) and a temperature of 38° C. Following this, washing with well water was carried out by means of a spray.

The current density was about 30 A/dm² in both cases. The final amount of oxidized film was 2.7 g/m².

(k) Alkali Metal Silicate Treatment

The aluminum support obtained by the anodizing treatment was immersed in a treatment vessel with a 4 wt % aqueous solution of sodium silicate No. 1 at a temperature of 30° C. for 10 sec. so as to carry out an alkali metal silicate treatment (silicate treatment). After this, washing with well water was carried out by means of a spray. In this case, the amount of silicate deposited was 5.5 mg/m².

Support C was thus obtained.

The surface-treated reverse side of the support C obtained above was provided with the same backcoat layers as in Examples 1 to 3 and Comparative Examples 1 and 2 to give Examples 7 to 9 and Comparative Examples 7 and 8. In Comparative Example 9, a backcoat was not provided.

### Formation of Organic Undercoat Layer

The surface-treated side of the support of Example 7 to Example 9 and Comparative Example 7 to Comparative Example 9 with the backcoat layer provided was coated with the organic undercoat solution below by means of a bar coater and dried at 80° C. for 15 sec. to give an organic undercoat layer at a dry coat weight of 18 mg/m².

| | | |
|---|---|---|
| Polymer compound below | 0.3 | parts by weight |
| Methanol | 100 | parts by weight |

| | |
|---|---|
| 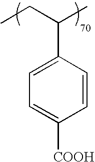 | 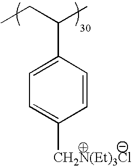 |

Polymer compound

### Formation of Recording Layer

The surface of the organic undercoat layer provided as above was coated with the recording layer-forming coating solution 3 below by means of a bar coater and dried in a PH200 PERFECT OVEN manufactured by Tabai Espec Co. at 130° C. for 50 sec. to give a recording layer at a dry coat weight of 0.85 g/m². Following this, it was coated with the recording layer-forming coating solution 4 below by means of a bar coater and dried in a PH200 PERFECT OVEN manufactured by Tabai Espec Co. at 130° C. for 60 sec. to give a recording layer at a dry coat weight of 0.22 g/m², thus giving infrared-sensitive lithographic printing plates of Example 7 to Example 9, and Comparative Example 7 to Comparative Example 9.

Recording layer-forming coating solution 3

| | |
|---|---|
| N-(4-Aminosulfonylphenyl)methacrylamide/acrylonitrile/methyl methacrylate | 1.9 parts by weight |
| copolymer (36/34/30 wt %: weight-average molecular weight 50,000, acid value | |
| 2.65) | |
| m-/p-Cresol novolac | 0.3 parts by weight |
| (m/p = 6/4, weight-average molecular weight 4,500, containing unreacted cresol | |
| at 0.8 wt %) | |
| Cyanine dye A above | 0.13 parts by weight |
| 4,4′-Bishydroxyphenylsulfone | 0.13 parts by weight |
| Tetrahydrophthalic anhydride | 0.19 parts by weight |
| p-Toluenesulfonic acid | 0.008 parts by weight |
| 3-Methoxy-4-diazodiphenylamine hexafluorophosphate | 0.032 parts by weight |
| Ethyl violet with counterion changed to 6-hydroxy-2-naphthalenesulfonate ion | 0.078 parts by weight |
| Megafac F780 (F-based surfactant, manufactured by Dainippon Ink and | 0.2 parts by weight |
| Chemicals, Inc., methyl ethyl ketone 30%) | |
| Methyl ethyl ketone | 25.0 parts by weight |
| 1-Methoxy-2-propanol | 13.0 parts by weight |
| γ-Butyrolactone | 13.0 parts by weight |

Recording layer-forming coating solution 4

| | |
|---|---|
| Phenol/m-/p-cresol novolac (phenol/m/p = 5/3/2, weight-average molecular | 0.27 parts by weight |
| weight 5,000, containing unreacted cresol at 0.8 wt %) | |
| Acrylic resin B above | 0.042 parts by weight |
| Cyanine dye A above | 0.019 parts by weight |
| Sulfonium salt compound D above | 0.065 parts by weight |
| Compound Y above | 0.004 parts by weight |
| Megafac F780 (F-based surfactant, manufactured by Dainippon Ink and | 0.02 parts by weight |
| Chemicals, Inc., methyl ethyl ketone 30%) | |
| F-based surfactant E above (methyl ethyl ketone 60%) | 0.032 parts by weight |
| Methyl ethyl ketone | 13.0 parts by weight |
| 1-Methoxy-2-propanol | 7.0 parts by weight |

### Evaluation

With regard to the infrared-sensitive lithographic printing plates of the Examples and Comparative Examples thus obtained, ‘1. Hardness of backcoat layer’ was measured in the same manner as above, and ‘2. Occurrence of scratching during transport’ and ‘3. Occurrence of scratching in autoloader’ were evaluated by the same methods as above. The results are given in Table 2.

TABLE 2

| | | | Vickers | | |
|---|---|---|---|---|---|
| | | | hardness | Occurrence | |
| | | | of | of scratching | Occurrence |
| | | Backcoat | backcoat | during | of scratching |
| | Support | layer | layer | transport | in autoloader |
| Ex. 7 | C | Coated with | 0.02 | Good | Good |
| | | urethane | | | |
| | | oligomer | | | |
| | | and then | | | |
| | | photocured | | | |
| Ex. 8 | C | Coated with | 0.02 | Good | Good |
| | | urethane | | | |
| | | oligomer | | | |
| | | and then | | | |
| | | photocured | | | |
| Ex. 9 | C | Ethylene- | 0.03 | Good | Good |
| | | butadiene | | | |
| | | rubber | | | |
| Comp. | C | Sol-gel | 0.8 | Poor | Poor |
| Ex. 7 | | | | | |
| Comp. | C | Saturated | 0.3 | Poor | Poor |
| Ex. 8 | | polyester | | | |
| | | resin | | | |
| Comp. | C | None | 1.2 | Poor | Poor |
| Ex. 9 | | | | | |

As is clear from Table 2, the infrared-sensitive lithographic printing plate of the present invention exhibited good results even when the surface treatment conditions for the support and the recording layer composition were changed.

What is claimed is:

1. An infrared-sensitive lithographic printing plate comprising:
a support;
a recording layer on one side of the support, the recording layer being capable of forming an image by irradiation with infrared rays; and
a backcoat layer on the side of the support opposite to the side having the recording layer, the backcoat layer having a Vickers hardness of 0.2 or less.

2. The infrared-sensitive lithographic printing plate according to claim 1, wherein the recording layer comprises an infrared-absorbing agent.

3. The infrared-sensitive lithographic printing plate according to claim 1, wherein the backcoat layer has a Vickers hardness of 0 to 0.03.

4. The infrared-sensitive lithographic printing plate according to claim 1, wherein the backcoat layer is a layer formed by curing with ultraviolet rays a layer comprising a urethane oligomer and/or an acrylic oligomer, a polyfunctional unsaturated monomer, and a polymerization initiator.

5. The infrared-sensitive lithographic printing plate according to claim 1, wherein the backcoat layer is a layer formed by curing with ultraviolet rays a layer comprising a urethane oligomer, a polyfunctional unsaturated monomer, and a polymerization initiator.

6. The infrared-sensitive lithographic printing plate according to claim 1, wherein the backcoat layer is formed by bonding by an adhesive a sheet of a rubber selected from the group consisting of natural rubber, isoprene rubber, styrene-butadiene rubber, butadiene rubber, chloroprene rubber, acrylonitrile-butadiene rubber, ethylene-propylene rubber, butyl rubber, fluorine rubber, silicone rubber, and urethane rubber.

7. The infrared-sensitive lithographic printing plate according to claim 1, wherein the recording layer has a multilayer structure of two or more layers and comprises a recording layer lower layer containing a water-insoluble and alkali-soluble resin and a recording layer uppermost layer containing a water-insoluble and alkali-soluble resin in that order, at least one of the recording layer lower layer and the recording layer uppermost layer comprising a photothermal conversion agent.

8. The infrared-sensitive lithographic printing plate according to claim 1, wherein the backcoat layer is present in an amount of 0.2 to 20 g/m².
